(19) United States
(12) Patent Application Publication
(10) Pub. No.: US 2026/0008013 A1
(43) Pub. Date: Jan. 8, 2026

(54) ISOTOPE SEPARATION SYSTEM WITH A SPLIT CRUCIBLE COLLECTION ASSEMBLY

(71) Applicant: SHINE Technologies, LLC, Janesville, WI (US)

(72) Inventors: Kenneth Kearney, Verona, WI (US); Zachary Childs, Madison, WI (US); Matthew Critchley, Brooklyn, WI (US)

(73) Assignee: SHINE Technologies, LLC, Janesville, WI (US)

(21) Appl. No.: 19/259,779

(22) Filed: Jul. 3, 2025

Related U.S. Application Data
(60) Provisional application No. 63/667,890, filed on Jul. 5, 2024.
(60) Provisional application No. 63/698,427, filed on Sep. 24, 2024.

(51) Int. Cl. B01D 59/02

(52) U.S. Cl. CPC B01D 59/02

(57) ABSTRACT

A split collection crucible assembly that includes a collection crucible and a collection cooling plate comprising a first plate portion removably coupled to a second plate portion, wherein when the first plate portion and the second plate portion are in an engaged position, a crucible slot is formed between the first plate portion and the second plate portion and the collection crucible is positionable in the crucible slot.

### CROSS-REFERENCE TO RELATED APPLICATIONS

This application claims the benefit of U.S. Provisional Application No. 63/667,890 filed on Jul. 5, 2024 and U.S. Provisional Application No. 63/698,427 filed on Sep. 24, 2024, which are each incorporated herein by reference in their entireties.

### TECHNOLOGY

The present disclosure is generally related to isotope separation systems. More particularly, the present disclosure is directed to isotope separation systems for the accumulation of target radioisotopes.

### BACKGROUND

Lutetium-177 (Lu-177) is a radioisotope that is used in the treatment of neuro endocrine tumors, prostate, breast, renal, pancreatic, and other cancers. In the coming years, approximately 70,000 patients per year will need Lu-177 during their medical treatments.

Accordingly, a need exists for improved techniques of separating and purifying radioisotopes, such as Lu-177.

### SUMMARY

According to one embodiment of the present disclosure, a split collection crucible assembly includes a collection crucible and a collection cooling plate comprising a first plate portion removably coupled to a second plate portion, wherein when the first plate portion and the second plate portion are in an engaged position, a crucible slot is formed between the first plate portion and the second plate portion and the collection crucible is positionable in the crucible slot.

According to another embodiment of the present disclosure, a split collection crucible assembly includes a collection cooling plate comprising a crucible slot and a collection crucible positioned in the crucible slot, wherein: the collection crucible comprises a first crucible portion removably coupled to a second crucible portion; the first crucible portion and the second crucible portion each comprise an interior assembly surface extending from an open end of the collection crucible to a closed end of the collection crucible; and contact between the interior assembly surfaces of the first crucible portion and the second crucible portion forms a releasable interface that seals the closed end of the collection crucible.

According to another embodiment of the present disclosure, a modular crucible loading unit includes a heating assembly comprising a crucible heater and a reaction crucible and a split collection crucible assembly comprising a collection crucible and a collection cooling plate, wherein the collection cooling plate comprises a crucible slot, the collection crucible is positioned in the crucible slot, at least one of the collection crucible and the collection cooling plate are split into two portions; and the heating assembly is removably engageable with the split collection crucible assembly into an engaged position in which an open end of the reaction crucible faces an open end of the collection crucible.

According to another embodiment of the present disclosure, a method includes heating a crucible heater of a heating assembly, wherein the heating assembly comprises a reaction crucible, a reaction material comprising a first element and a second element is positioned in the reaction crucible. The method also includes heating the crucible heater also heats the reaction material such that at least a portion of the first element phase separates from the reaction material to leave a higher weight composition of the second element in the reaction crucible than was present in the reaction crucible and collecting the first element in a collection crucible of a split collection crucible assembly, wherein the split collection crucible assembly further comprises a collection cooling plate comprising a crucible slot, the collection crucible is positioned in the crucible slot, and at least one of the collection crucible and the collection cooling plate are split into two portions.

According to yet another embodiment of the present disclosure, a method includes inserting a modular crucible loading unit into a docking station housed in a vacuum chamber, thereby electrically coupling a busbar of a heating assembly of the modular crucible loading unit to a power socket port of the docking station and thermally coupling a collection cooling plate of a split collection crucible assembly of the modular crucible loading unit to a cold plate of the docking station, wherein the heating assembly further comprises a reaction crucible and a crucible heater, wherein the crucible heater is electrically coupled to the busbar; the collection cooling plate comprises a crucible slot; a collection crucible is positioned in the crucible slot; and at least one of the collection crucible and the collection cooling plate are split into two portions; and the heating assembly is coupled to the split collection crucible assembly such that an open end of the reaction crucible faces an open end of the collection crucible.

Additional features and advantages of the systems and methods disclosed herein will be set forth in the detailed description that follows, and in part will be readily apparent to those skilled in the art from that description or recognized by practicing the embodiments described herein, including the detailed description that follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments and are incorporated into and constitute a part of this specification. The drawings illustrate the various embodiments described herein, and together with the description serve to explain the principles and operations of the claimed subject matter.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an isometric view of an isotope separation system that includes a modular crucible loading unit engaged with a docking station, according to one or more embodiments shown and described herein;

FIG. 2 schematically depicts an isometric view of the isotope separation system of FIG. 1 where the modular crucible loading unit is disengaged with the docking station, according to one or more embodiments shown and described herein;

FIG. 3A schematically depicts an isometric view of an example modular crucible loading unit, according to one or more of the embodiments shown and described herein;

FIG. 3B is a cross-sectional view of the modular crucible loading unit of FIG. 3A, according to one or more of the embodiments shown and described herein;

FIG. 4A schematically depicts an example paired crucible system of a modular crucible loading unit, according to one or more of the embodiments shown and described herein;

FIG. 4B schematically depicts another example paired crucible system of a modular crucible loading unit, according to one or more of the embodiments shown and described herein;

FIG. 4C schematically depicts yet another example paired crucible system of a modular crucible loading unit, according to one or more of the embodiments shown and described herein;

FIG. 5A schematically depicts an isometric view of a split collection crucible assembly, according to one or more embodiments shown and described herein;

FIG. 5B schematically a top view of a split collection crucible assembly, according to one or more embodiments shown and described herein;

FIG. 5C schematically depicts a first plate portion and a first crucible portion of the split collection crucible assembly of FIGS. 5A and 5B, according to one or more embodiments shown and described here;

FIG. 5D schematically depicts a split collection crucible, according to one or more embodiments shown and described herein;

FIG. 5E schematically depicts a single crucible portion of the split collection crucible of FIG. 5D, according to one or more embodiments shown and described herein;

FIG. 6A schematically depicts schematically depicts an isometric view of another split collection crucible assembly, according to one or more embodiments shown and described herein;

FIG. 6B schematically depicts schematically depicts a bottom view of the split collection crucible assembly of FIG. 6A, according to one or more embodiments shown and described herein;

FIG. 7A schematically depicts a cutaway portion of the isotope separation system of FIGS. 1 and 2, where alignment protrusions of the modular crucible loading unit is disengaged with alignment slots of the docking station and busbars of the modular crucible loading unit are disengaged with power socket ports of the docking station, according to one or more embodiments shown and described herein;

FIG. 7B schematically depicts a cutaway portion of the isotope separation system of FIGS. 1 and 2, where alignment protrusions of the modular crucible loading unit are engaged with alignment slots of the docking station and busbars of the modular crucible loading unit are disengaged with power socket ports of the docking station, according to one or more embodiments shown and described herein;

FIG. 7C schematically depicts a cutaway portion of the isotope separation system of FIGS. 1 and 2, where alignment protrusions of the modular crucible loading unit are disengaged with alignment slots of the docking station and busbars of the modular crucible loading unit are engaged with power socket ports of the docking station, according to one or more embodiments shown and described herein;

FIG. 8A schematically depicts a side view of the isotope separation system of FIGS. 1 and 2, where the modular crucible loading unit is engaged with the docking station, according to one or more embodiments shown and described herein; and

FIG. 8B schematically depicts a side view of the isotope separation system of FIGS. 1 and 2, where the modular crucible loading unit is disengaged with the docking station, according to one or more embodiments shown and described herein.

### DETAILED DESCRIPTION

Referring generally to the figures, embodiments of the present disclosure are directed to a split collection crucible assembly for the accumulation of a target radioisotope, such as a target rare earth radioisotope, for example, lutetium-177 (“Lu-177”). The split collection crucible assembly includes a collection crucible and a collection crucible plate. The collection cooling plate includes a first and a second plate portion that are removably coupled to allow for easier access to the collection crucible and to a material collected in the collection crucible, while reducing the likelihood of damaging the collection crucible. The collection crucible may include a first crucible portion and a second crucible portion that, similar to the first and second plate portions, are removably coupled to allow for easier access to material collected in the collection crucible. The split collection crucible assembly may be part of an isotope separation system that includes a docking station housed within a vacuum chamber and a modular crucible loading unit that is removably engageable with the docking station.

The modular crucible loading unit includes a heating assembly removably coupled to the split collection crucible assembly. The heating assembly comprises a crucible heater, a busbar electrically coupled to the crucible heater, and a reaction crucible. The reaction crucible of the heating assembly and the collection crucible collectively form a paired crucible system. When the heating assembly is coupled to the split collection crucible assembly, an open end of the reaction crucible faces an open end of the collection crucible. The modular crucible loading unit allows the reaction crucible and the collection crucible to be fixed in alignment with one another to form the paired crucible system before they enter the vacuum chamber for processing.

The isotope separation system may have multiple uses during a target isotope accumulation process. The isotope separation system may be used during a reduction process to reduce a rare earth metal, such as ytterbium, for example, ytterbium-176 (“Yb-176”), from a rare earth oxide and collect the rare earth metal and may be used during a cold separation process to purify the rare earth metal. The purified rare earth metal may then be irradiated with neutrons to form an irradiated composition comprising a first element (such as lutetium, for example, Lu-177) and a second element (such as ytterbium, for example Yb-176). The isotope separation system may also be used during a hot separation process to support separation of the second element (such as ytterbium) from the irradiated composition comprising the first element (such as lutetium) and the second element and collection of both the first element and the second element with minimal loss of either. For example, this hot separation may occur by sublimating or distilling the second element from the composition and collecting both the separated second element and a remaining first element. The remaining first element may compromise high purity isotopes of lutetium, such as Lu-177 separated from an irradiated composition comprising ytterbium and lutetium. The collected separated second element, such as ytterbium, then undergoes a waiting period, while any radioactive material in the separated rare earth element decays. The isotope separation system may then be used in another cold separation process to purify the decayed second element, which may be irradiated again to form another irradiated composition comprising the first element and the second element.

Thus, the isotope separation system facilitates the collection of a target rare earth element, such as lutetium, for example Lu-177, while also facilitating the recycling and reuse of the separated rare earth element, such as ytterbium, for example, ytterbium-176 (Yb-176), which may then be used to generate more of the target radioisotope. The repeatable and reliable positioning of the components of the modular crucible loading unit during the target isotope accumulation process minimizes loss of ytterbium during the reduction process and the cold separation process and minimizes the loss of both lutetium and ytterbium (in both their separated compositional form and a combined compositional form) during the hot separation process, which are rare and expensive materials. This allows the lutetium and ytterbium to be reprocessed with minimal loss, and used to collect additional high purity lutetium, such as additional Lu-177. Indeed, the split sublimation crucible assembly provides easier access to collected material, such as collected ytterbium, increasing the percentage of the collected ytterbium that can be removed for recycling and reprocessing.

Lu-177 is used in the treatment of neuro endocrine tumors, prostate, breast, renal, pancreatic, and other cancers. Lu-177 is useful for many medical applications, because during decay it emits a low energy beta particle that is suitable for treating tumors. It also emits two gamma rays that can be used for diagnostic testing. Isotopes with both treatment and diagnostic characteristics are termed “theranostic.” Not only is Lu-177 theranostic, but it also has a 6.65-day half-life, which allows for more complicated chemistries to be employed, as well as allowing for easy global distribution. Lu-177 also exhibits chemical properties that allow for binding to many bio molecules, for use in a wide variety of medical treatments.

There are two main production pathways to produce Lu-177. One is via a neutron capture reaction on Lu-176; Lu-176 (n,γ) Lu-177. This production method is referred to as carrier added (ca) Lu-177. A carrier is an isotope(s) of the same element (Lu-177m in this case), or similar element, in the same chemical form as the isotope of interest. In microchemistry the chemical element or isotope of interest does not chemically behave as expected due to extremely low concentrations. Moreover, isotopes of the same element cannot be chemically separated, and require mass separation techniques. The carrier method, therefore, results in the produced Lu-177 having limited medical application.

The second production method for Lu-177 is a neutron capture reaction on ytterbium-176 (Yb-176) (Yb-176 (n,γ) Yb-177) to produce Yb-177. Yb-177 then rapidly (t½ of 1.911 hours) beta-decays into Lu-177. This process is considered a “no carrier added” process. The process may be carried out as ytterbium metal or ytterbium oxide. The isotope separation system described herein may be used for the separation of ytterbium and lutetium obtained from a no carrier added process. While the isotope separation system is primarily described herein in relation to the separation of ytterbium and lutetium, it should be understood that the isotope separation system may be used to facilitate separation of a variety of elements, for example any of the rare earth, and/or actinide metals where there is a difference in boiling/sublimation point, such as cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb), and yttrium (Y).

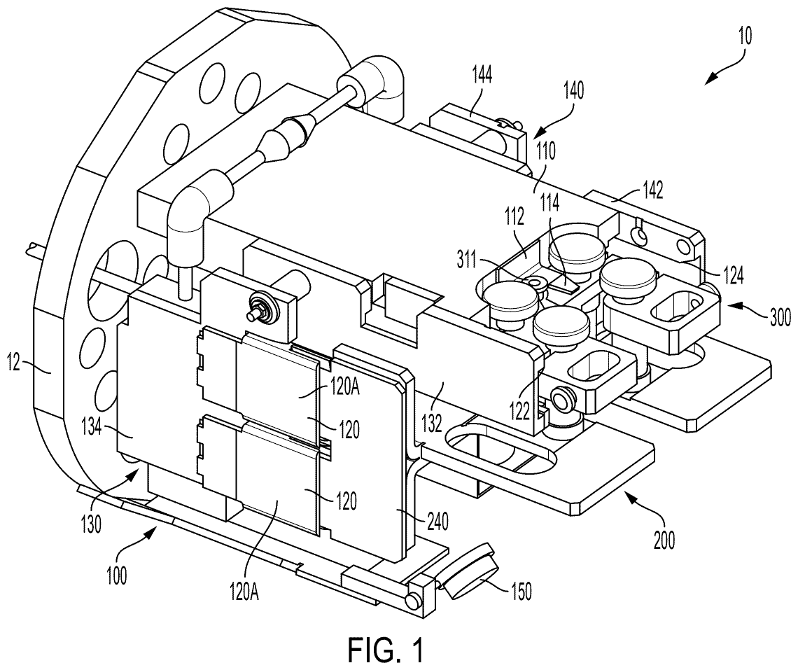

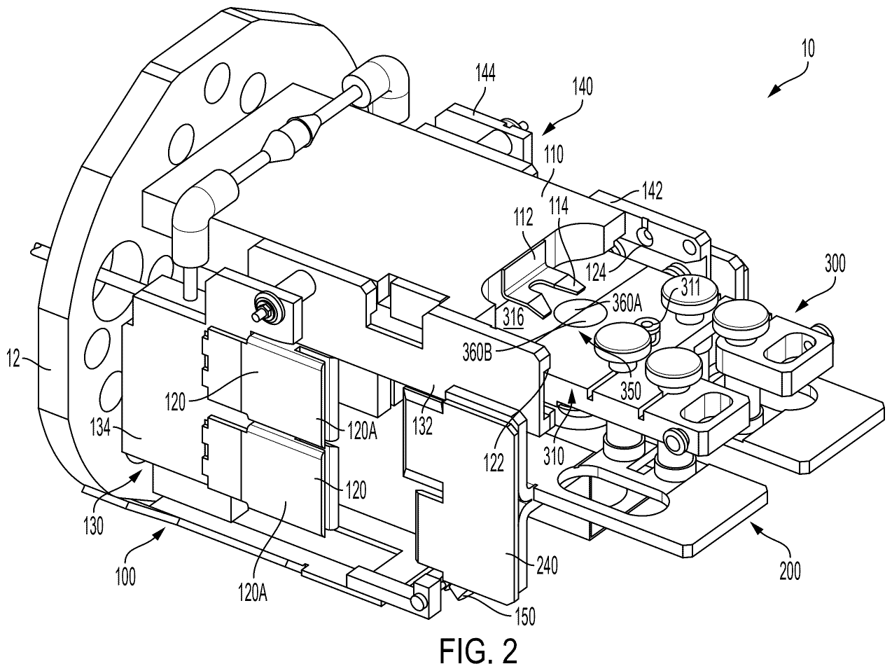

Referring now to FIGS. 1 and 2, an isotope separation system 10 is depicted that comprises a modular crucible loading unit 200 that is removably engageable with a docking station 100. The modular crucible loading unit 200 comprises a heating assembly 210 removably coupled to a split collection crucible assembly 300. FIG. 1 depicts the modular crucible loading unit 200 engaged with the docking station 100 and FIG. 2 depicts the modular crucible loading unit 200 disengaged with the docking station 100. The docking station 100 comprises a power socket port 120 and a cold plate 110. In some embodiments, the docking station 100 is mounted within a vacuum chamber 12 such that, when the modular crucible loading unit 200 is engaged with the docking station 100, the modular crucible loading unit 200 is also positioned in the vacuum chamber 12.

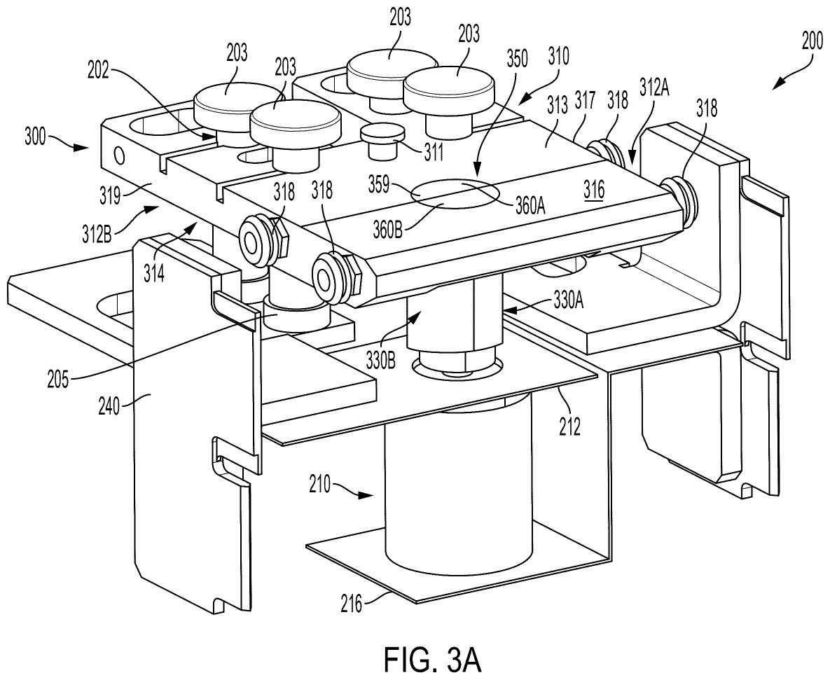

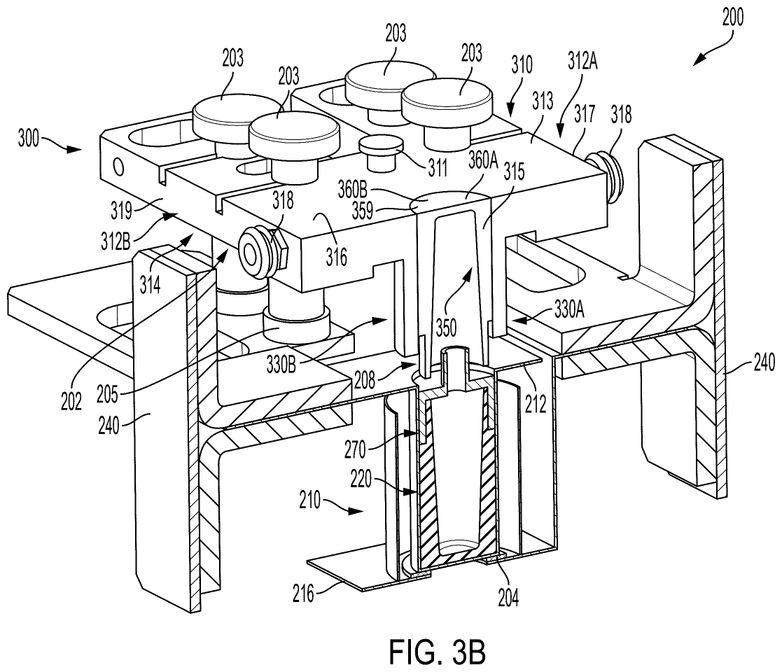

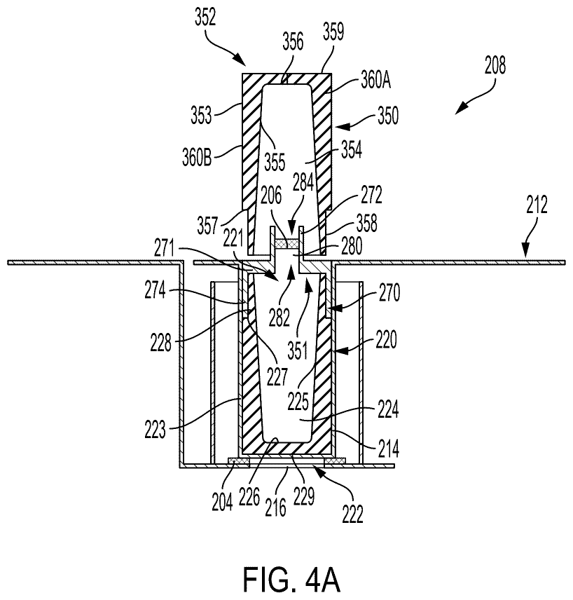

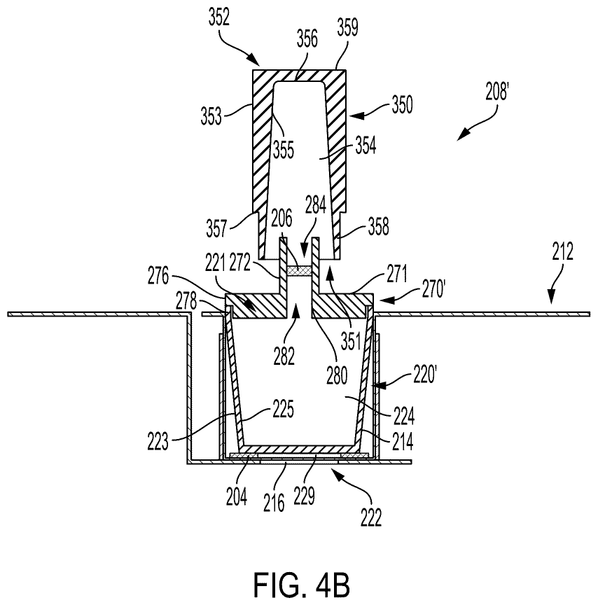

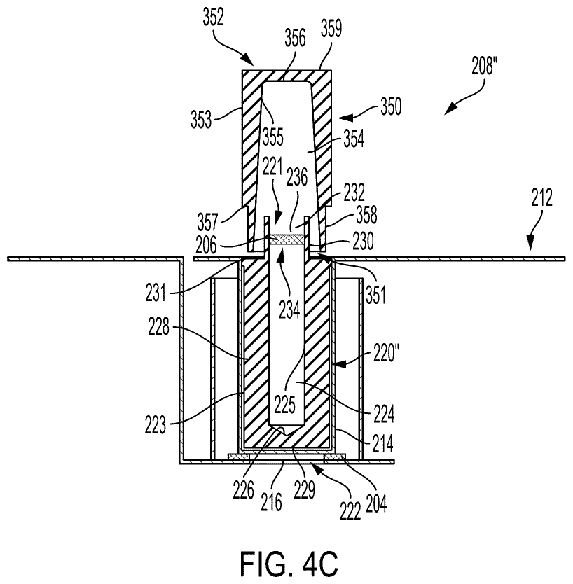

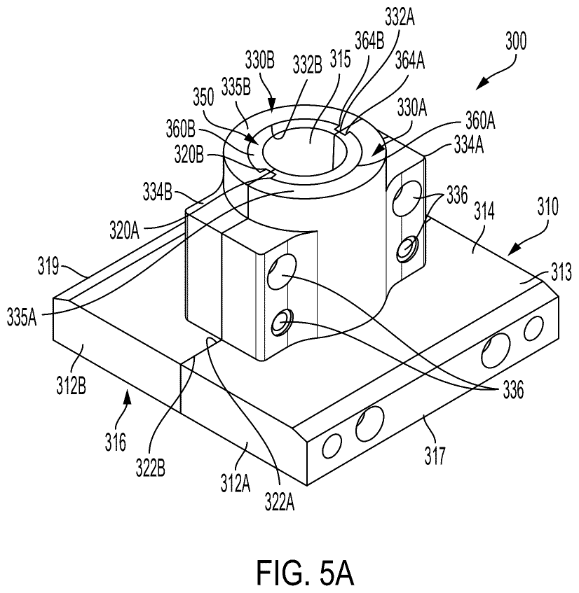

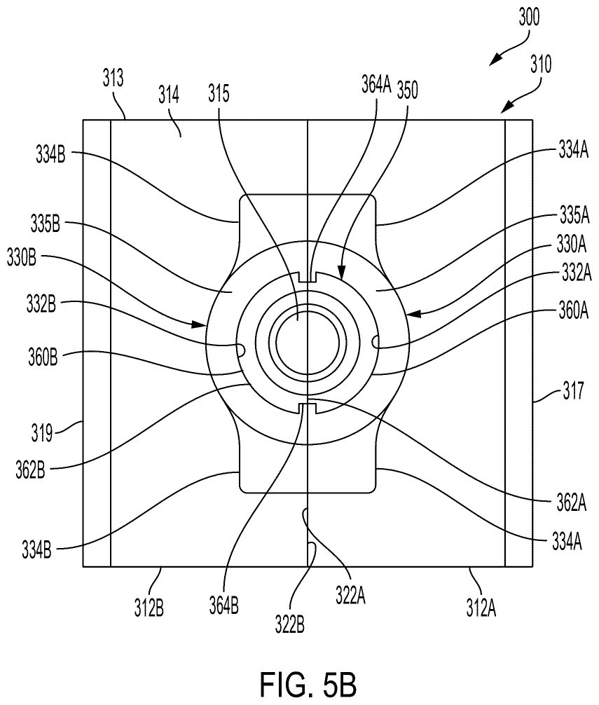

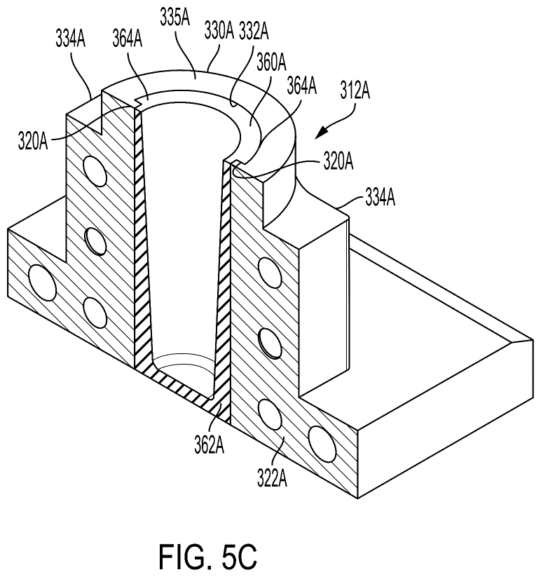

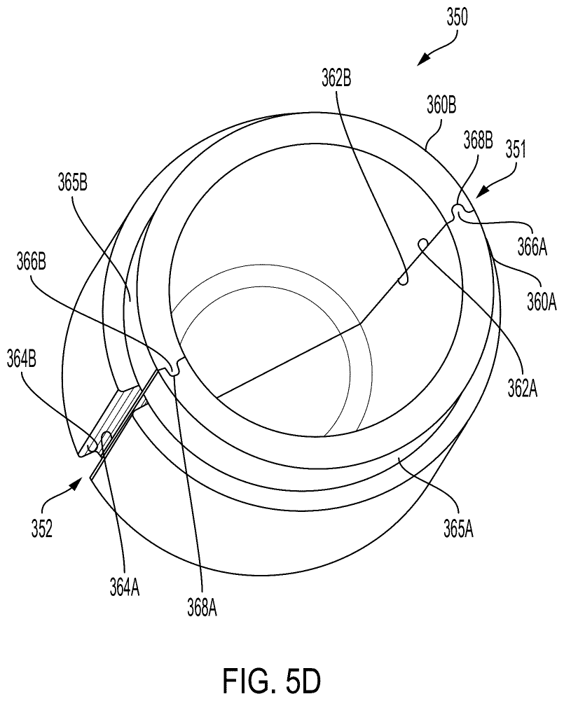

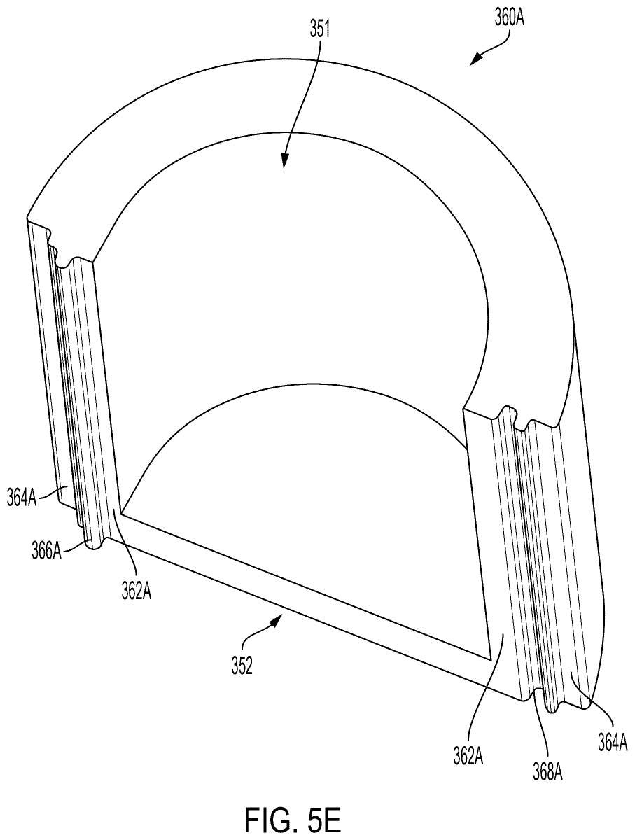

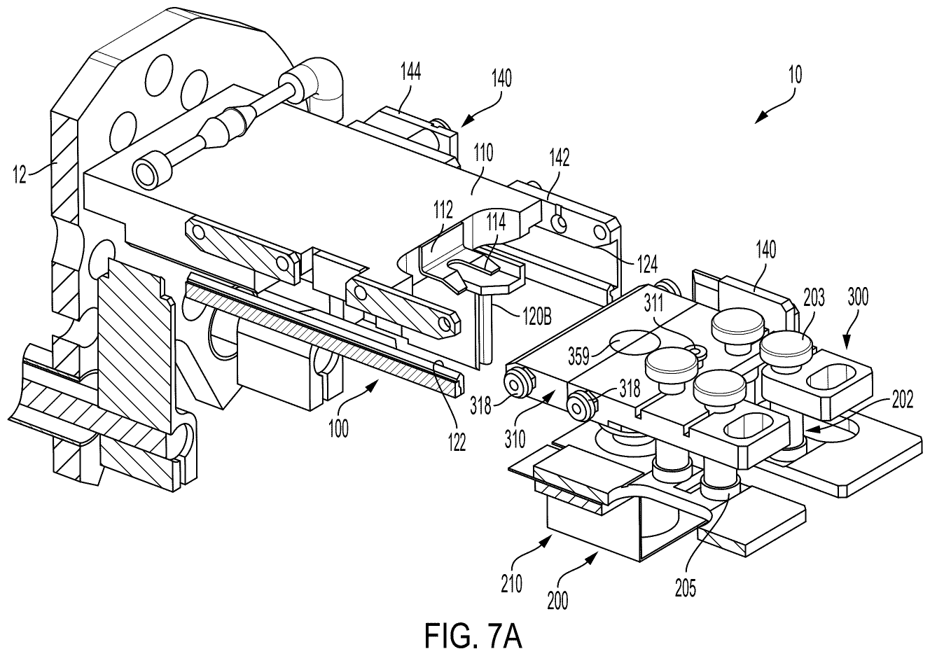

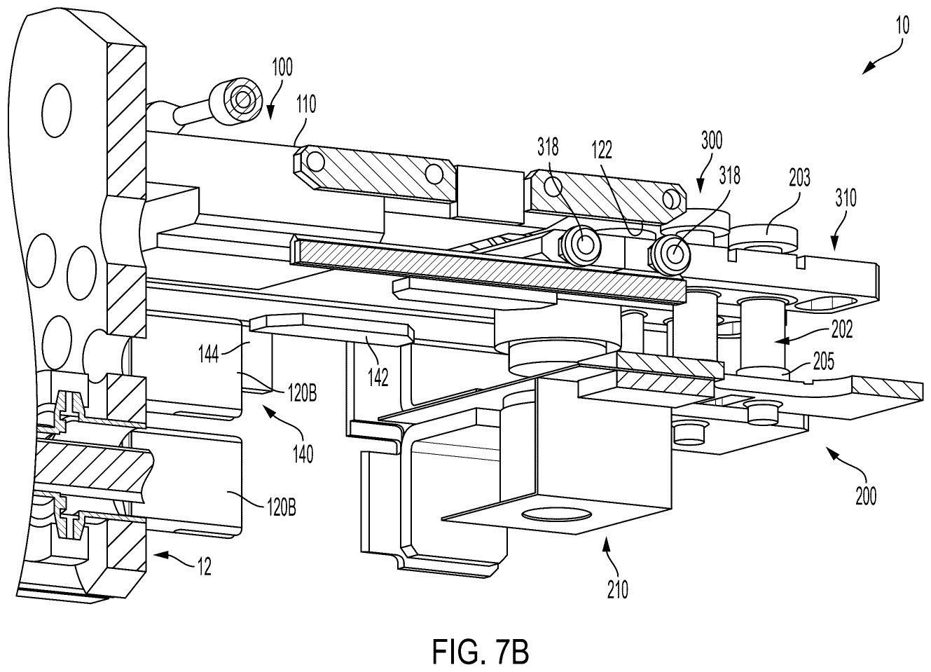

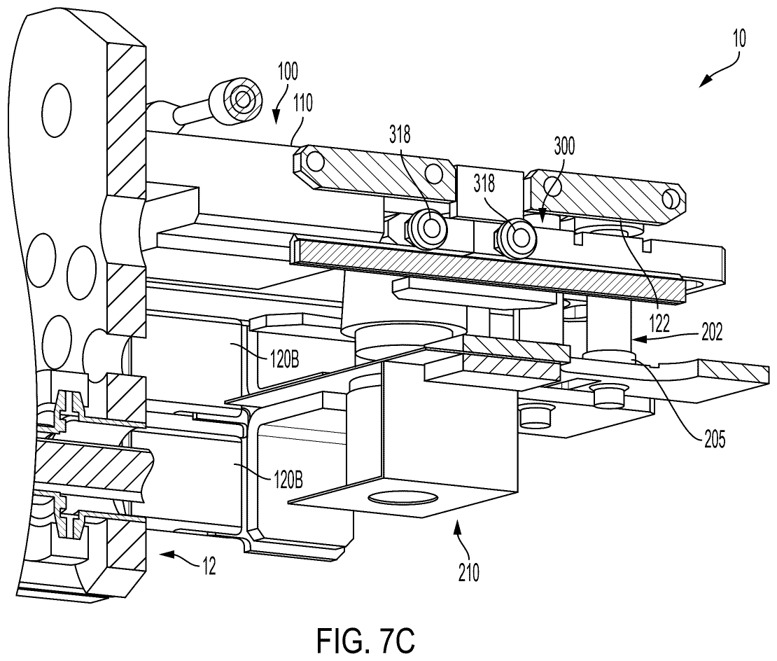

Referring also to FIGS. 3A-4C, the heating assembly 210 of the modular crucible loading unit 200 comprises a crucible heater 212, a busbar 240 electrically coupled to the crucible heater 212, and a reaction crucible 220, 220′, 220″. The split collection crucible assembly 300 comprises the collection cooling plate 310, which may include a first plate portion 312A and a second plate portion 312B, and a collection crucible 350, which may include a first crucible portion 360A and a second crucible portion 360B. As depicted in FIGS. 3A and 3B, the collection cooling plate 310 may be split such that the interface formed between the first plate portion 312A and the second plate portion 312B extends from a first side surface 317 of the collection cooling plate 310 to a second side surface 319 of the collection cooling plate 310. However, it should be understood that the collection cooling plate 310 may be split in other ways, for example, split longways such that the first side surface 317 is part of the first plate portion 312A and second side surface 319 is part of the second plate portion 312B. In some embodiments of the split collection crucible assembly 300, both the collection cooling plate 310 and the collection crucible 350 are split (see FIGS. 4B, 5A, and 6A-6D). In other embodiments of the split collection crucible assembly 300, the collection cooling plate 310 is split while the collection crucible 350 comprises a unitary crucible (see FIGS. 5B, 7A, and 7B). In other embodiments of the split crucible collection assembly 300, the collection crucible 350 is split and the collection cooling plate 310 is unitary (see FIGS. 5D and 5E). Indeed, in some embodiments, at least one of the collection crucible 350 and the collection cooling plate 310 are split into two portions, for example, the collection cooling plate 310, the collection crucible 350, or both.

The heating assembly 210 and the split collection crucible assembly 300 are removably coupled by one or more connectors 202. The one or more connectors 202 include a fastener portion 203 and a standoff portion 205. The standoff portion 205 comprises electrically non-conductive material, such as ceramic, and forms an electrical break between the heating portion 210 and the cooling portion 250. The standoff portion 205 may also include a threaded receiver for receiving the fastener portion 205. In some embodiments, the threader receiver is a metal material, while the remainder of the standoff portion 205 is electrically non-conductive material. In some embodiments, the fastener portion 203 comprises a manipulator screw, however, it should be understood that any type of fastener is contemplated. When the heating assembly 210 is coupled to the split collection crucible assembly 300, that is, when the modular crucible loading unit 200 is assembled, an open end 221 of the reaction crucible 220 faces an open end 351 of the collection crucible 350. Thus, the reaction crucible 220 and the collection crucible 350 can be fixed in alignment with one another before they enter the vacuum chamber 12 for processing. The reaction crucible 220, 220′, 220″ of the heating assembly 210 and the collection crucible 350 of the split collection crucible assembly 300 collectively form a paired crucible system 208, 208′, 208″.

This fixed alignment is retained when engaging the modular crucible loading unit 200 with the docking station 100, which provides electricity to the busbar 240 and thus the crucible heater 212 and positions the cold plate 110 proximate the collection cooling plate 310, for example, in direct contact. When the modular crucible loading unit 200 is engaged with the docking station 100, the busbar 240 of the heating assembly 210 is electrically coupled to the power socket port 120 of the docking station 100 and the collection cooling plate 310 is thermally coupled to the cold plate 110 of the docking station 100. Thus, the isotope separation system 10 provides repeatable and reliable positioning of the components of the modular crucible loading unit 200 during a target isotope accumulation process, minimizing loss of target materials while allowing the modular crucible loading unit 200 to be removed from the vacuum chamber 12 before unloading accumulated materials and performing additional processing.

Referring now to FIGS. 5A-5C, an example embodiment of the split collection crucible assembly 300 is schematically depicted in more detail. The split collection crucible assembly 300 comprises the collection cooling plate 310 and a collection crucible 350. The collection cooling plate 310 is split and comprises a first plate portion 312A removably coupled to a second plate portion 312B. The first plate portion 312A and the second plate portion 312B may be in an engaged position or a disengaged position. As shown in FIG. 5A, when the first plate portion 312A and the second plate portion 312B are in the engaged position, a crucible slot 315 is formed between the first plate portion 312A and the second plate portion 312B. When the first plate portion 312A and the second plate portion 312B are in the disengaged position, the first plate portion 312A is spaced apart from the second plate portion 312B. The first plate portion 312A comprises an interior assembly surface 322A and the second plate portion 312A comprises an interior assembly surface 322B. When the first plate portion 312A and the second plate portion 312B are in the engaged position, the interior assembly surface 322A of the first plate portion 312A faces, and may contact, the interior assembly surface 322B of the second plate portion 312A. The collection cooling plate 310 comprises a plate body 313, an underside surface 314 and a cold interfacing surface 316. The first plate portion 312A and the second plate portion 312B each form portions of the plate body 313, the underside surface 314, and the cold interfacing surface 316.

The first plate portion 312A further comprises a slot protrusion 330A positioned at the interior assembly surface 322A, extending from the underside surface 314, and terminating at a protrusion end 335A. The slot protrusion 330A includes a portion of the interior assembly surface 322A of the first plate portion 312A. Similarly, the second plate portion 312B comprises a slot protrusion 330B positioned at the interior assembly surface 322B, extending from the underside surface 314, and terminating at a protrusion end 335B. The slot protrusion 330B includes a portion of the interior assembly surface 322B of the second plate portion 312B. The slot protrusion 330A of the first plate portion 312A comprises a crucible receiving wall 332A and the slot protrusion 330B of the second plate portion 312B comprises a crucible receiving wall 332B. When the first plate portion 312A and the second plate portion 312B are in the engaged position, the crucible receiving wall 332A of the first plate portion 312A and the crucible receiving wall 332B and second plate portion 312B collectively define the crucible slot 315. In some embodiments, the crucible slot 315 extends into the plate body 313 from the underside surface 314. As depicted in FIGS. 3A and 3B, the crucible slot 315 may extend through the plate body 313 to the cold interfacing surface 316. When the modular crucible loading unit 200 is assembled, the collection crucible 350 is positioned in the crucible slot 315. In some embodiments, the base surface 359 of the collection crucible 350 is coincident with the cold interfacing surface 316.

In some embodiments, the slot protrusions 330A, 330B of the first and second plate portions 312A, 312B each comprise one or more fastener receiving juts 334A, 334B extending along the respective interior assembly surfaces 362A, 362B of the first and second plate portions 312A, 312B. One or more fastener holes 336A, 336B are positioned in the fastener receiving juts 334A, 334B. Fasteners may be positioned in the fastener receiving juts 334A, 334B to removably couple the first plate portion 312A and the second plate portion 312B. The one or more fastener holes 336A, 336B may include one or more through holes and one or more recessed holes. Fasteners positioned in the one or more through holes to may be used to clamp together the first and second plate portions 312A, 312B and fasteners, such as set screws, positioned in the one or more recessed holes may be used separate the first and second plate portions 312A, 312B.

In some embodiments, the first plate portion 312A and the second plate portion 312B are moveable, for example, translatable between the engaged position and the disengaged position using at least one of the plurality of fasteners. When the first plate portion 312A and the second plate portion 312B are moved into the disengaged position using at least one of the plurality of fasteners, the fastener may retain a connection between the first plate portion 312A and the second plate portion 312B, which are in a spaced arrangement. However, it is possible to disconnect the first plate portion 312A and the second plate portion 312B. Thus, it is contemplated that when the first plate portion 312A and the second plate portion 312B are in the disengaged position, they may be coupled or uncoupled. Moreover, the fastener receiving juts 334A, 334B remove the need for additional clamping components to position the first plate portion 312A and the second plate portion 312B in the engaged position or the disengaged positioned, such as a collar or other external clamping devices. In some embodiments, the first plate portion 312A and the second plate portion 312B are coupled together with a hinging device that facilitates engagement and disengagement of the first plate portion 312A and the second plate portion 312B by rotational motion. Such a hinging device may be included in addition to the fastener receiving juts 334A, 334B or instead of the fastener receiving juts 334A, 334B.

The collection crucible 350 is positionable in the crucible slot 315. In some embodiments, the collection crucible 350 is a unitary crucible. In other embodiments, as depicted in FIGS. 5A-5C, the collection crucible 350 is split and includes a first crucible portion 360A and a second crucible portion 360B. In some embodiments, the first crucible portion 360A may be coupled to the first plate portion 312A and the second crucible portion 360B may be coupled to the second plate portion 312B. In some embodiments, the collection crucible 350 is split and the collection cooling plate 310 is unitary.

Referring now to FIGS. 5D and 5E, an example split version of the collection crucible 350 is depicted. The first crucible portion 360A and the second crucible portion 360B each comprise an interior assembly surface 362A, 362B extending from an open end 351 of the collection crucible 350 to a closed end 352 of the collection crucible 350. Contact between the interior assembly surfaces 322A, 322B of the first crucible portion 360A and the second crucible portion 360B forms a releasable interface that seals the closed end 352 of the collection crucible 350. In some embodiments, the first crucible portion 360A and the second crucible portion 360B each comprise one or more edge notches 364A, 364B that form a gap between the first crucible portion 360A and the second crucible portion 360B when the interior assembly surfaces 362A, 362B of the first crucible portion 360A and the second crucible portion 360B are in contact. This gap may be useful to provide a location for pressing onto both crucible portions 360A, 360B, facilitating separation of the crucible portions 360A, 360B. Moreover, as shown in FIGS. 5A-5C, the edge notches 364A, 364B may be coupled to plate portions 312A, 312B of the collection cooling plate 310.

Referring again to FIGS. 5D and 5E, the first crucible portion 360A may comprise an interface protrusion 366A extending along the interior assembly surface 322A and an interface recess 368A extending along the interior assembly surface 322A (e.g., along opposite segments of the interior assembly surface 322A. Similarly, the second crucible portion 360B may comprise an interface protrusion 366B extending along the interior assembly surface and an interface recess extending along the interior assembly surface. When the crucible portions 360A, 360B are coupled, the interface protrusion 366A of the first crucible portion 360A is positioned in the interface recess 368B of the second crucible portion 360B and the interface protrusion 366B of the second crucible portion 360B is positioned in the interface recess 368A of the first crucible portion 360A, mating together the crucible portions 360A, 360B. This helps maintain the relative positioning of the crucible portions 360A, 360B. As depicted in FIG. 5D, the collection crucible 350 may comprise narrowed end portions 365A, 365B at the open end 351. As depicted in FIG. 5D, the interface protrusions 366A, 366B and the interface recesses 368A, 368B may extend into the narrowed end portions 365A, 365B, while the edge notches 364A, 364B may extend from the closed end 352 to the narrowed end portions 365A, 365B, terminating at the narrowed end portions 365A, 365B.

In some embodiments, the interface protrusion 366A of the first crucible portion 360A extends along the interior assembly surface 322A from the open end 351 to the closed end 352 and the interface recess 368A of the first crucible portion 360A extends along the interior assembly surface 322A from the open end 352 to the closed end 352. In some embodiments, the interface protrusion 366B of the second crucible portion 360B extends along the interior assembly surface 322B from the open end 351 to the closed end 352 and the interface recess 368B of the second crucible portion 360B extends along the interior assembly surface 322B from the open end 351 to the closed end 352. In other embodiments, the interface protrusions 366A and interface recesses 368A, 368B do not extend the full height of the interior assembly surfaces 322A, 322B, and may be located anywhere along the interior assembly surfaces 322A, 322B, for example, intermittently. Moreover, it should be understood that any mechanism or design for engaging the first and second crucible portions 360A, 360B is contemplated.

Referring again to FIGS. 5A-5C, in embodiments in which both the collection crucible 350 and the collection cooling plate 310 are split, when the first plate portion 312A and the second plate portion 312B are in the engaged position, the first crucible portion 360A contacts the second crucible portion 360B to form a collection chamber 354 in the collection crucible 350. Indeed, the first crucible portion 360A comprises an interior assembly surface 362A and the second crucible portion 360B comprises an interior assembly surface 362B. When the first plate portion 312A and the second plate portion 312B are in the engaged position, the interior assembly surface 362A of the first crucible portion 360A contacts the interior assembly surface 362B of the second crucible portion 360B, thereby sealing a closed end 352 of the collection crucible 350.

Referring still to FIGS. 5A-5C, the first plate portion 312A and the second plate portion 312B each comprise one or more edge protrusions 320A, 320B. Edge protrusions 320A of the first plate portion 312A are located where the interior assembly surface 322A of the first plate portion 312A meets the crucible receiving wall 332A of the first plate portion 312A. Similarly, edge protrusions 320B of the second plate portion 312B are located where the interior assembly surface 322B of the second plate portion 312B meets the crucible receiving wall 332B of the second plate portion 312B. The edge protrusions 320A of the first plate portion 312A may extend toward one another along the interior assembly surface 322A and the edge protrusions 320B of the second plate portion 312B may similarly extend toward one another along the interior assembly surface 322B.

The one or more edge protrusions 320A of the first plate portion 312A may be coupled to the one or more edge notches 364A of the first crucible portion 360A thereby coupling the first crucible portion 360A to the first plate portion 312A, for example, via a press fit engagement. Similarly, the one or more edge protrusions 320B of the second plate portion 312B are coupled to the one or more edge notches 364B of the second crucible portion 360B thereby coupling the second crucible portion 360B to the second plate portion 312B, for example, via a press fit engagement. Thus, the first crucible portion 360A may remain coupled to the first plate portion 312A and the second crucible portion 360B may remain coupled to the second plate portion 312B when the first and second plate portions 312A, 312B are in the disengaged position. This facilitates increased ease of access to material collected in the collection crucible 350 while minimizing the complexity of coupling and uncoupling the first crucible portion 360A and the second crucible portion 360B. In some embodiments, the first and second crucible portions 360A are not press fit to the first and second plate portion 312A, 312B, respectively, and are engaged in another manner, for example, using fasteners or using frictional force provided by the engagement of the first and second plate portions 312A, 312B.

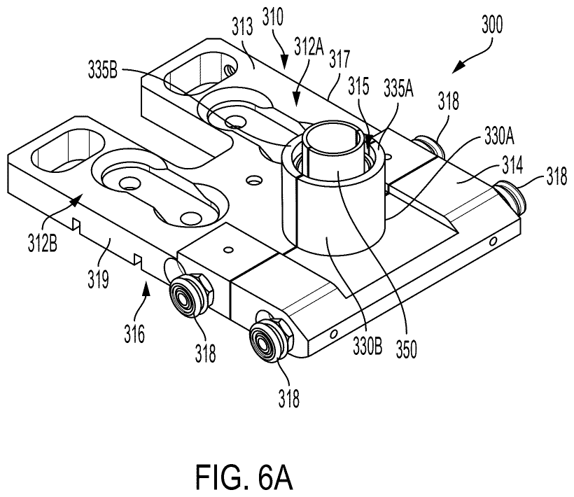

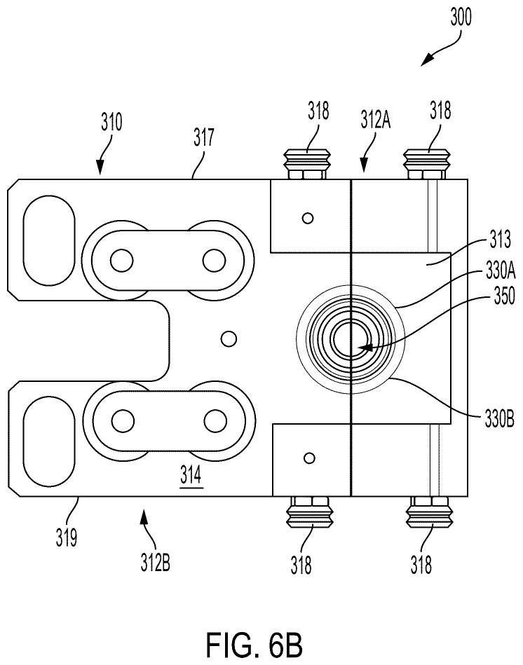

In FIGS. 6A and 6B, another embodiment of the split collection crucible assembly 300 is depicted. In FIGS. 6A and 6B, the collection crucible 350 is a unitary crucible and the open end 351 of the collection crucible 350 extends beyond the protrusion end 335A, 335B of the slot protrusion 330A, 330B. For example, the narrowed end portions 365A, 365B may extend beyond the protrusion end 335A, 335B It should be understood that embodiments in which the protrusion end 335A, 335B is flush with the open end 351 of the collection crucible (e.g., FIGS. 5A-5C) and embodiments in which the open end 351 extends beyond the protrusion end 335A, 335B are contemplated and these embodiments are contemplated for both split collection crucibles and unitary collection crucible. Extending the open end 351 (e.g., the narrowed end portions 365A, 365B) beyond the protrusion end 335A, 335B encourages deposition of any collected material nearer the closed end 352 than the open end 351, which reduces the likelihood of collected material forming a stalactite of material extending from the open end 351. Such a stalactite of material could reach the reaction crucible 220, 220′, 220″, creating an unwanted electrical pathway between the reaction crucible 220, 220′, 220″ and the collection crucible 360.

Referring now to FIGS. 5A-6B, splitting the collection cooling plate 310 into the first plate portion 312A and the second plate portion 312B allows for easier removal of the collection crucible 350 from the slot protrusion 330A, 330B. The collection crucible 350 does not need to be slid out of the collection slot 330A, 330B. In addition, the first and second plate portions 312A, 312B reduce the likelihood of the collection crucible 350 getting stuck in the slot protrusion 330A, 330B and reduce the likelihood of damage to the collection crucible 360, which is often performed using robotic manipulators when the split collection crucible assembly 300 is positioned in a radioactive environment.

Referring again to FIG. 4A, the paired crucible system 208 is depicted. The paired crucible system 208 comprises the reaction crucible 220 and the collection crucible 350. The reaction crucible 220 comprises a crucible body 223 and a closed end 222 opposite the open end 221 and a reaction chamber 224. The reaction chamber 224 includes a chamber surface 225. A portion of the chamber surface 225 forms a chamber floor 226, which is the portion of the chamber surface 225 at the closed end 222 of the reaction crucible 220. The closed end 222 terminates at a base surface 229 of the reaction crucible 220. In some embodiments, the reaction crucible 220 includes an end shoulder 227 comprising an interfacing edge 228 terminating at the open end 221.

The collection crucible 350 comprises a crucible body 353 and the closed end 352 opposite the open end 351 and the collection chamber 354. The collection chamber 354 includes a collection surface 355. A portion of the collection surface 355 forms a collection floor 356, which is the portion of the collection surface 355 at the closed end 352 of the collection crucible 350. The closed end 352 terminates at a base surface 359 of the collection crucible 350. In some embodiments, the collection crucible 350 includes an end shoulder 357 comprising an interfacing edge 358 terminating at the open end 351. In FIG. 4A, the collection crucible 350 is a split crucible. In embodiments in which the collection crucible 350 is a split crucible, such as FIG. 4A, the first crucible portion 360A and the second crucible 360B each form portions of the crucible body 353, the collection chamber 354, the collection surface 355, the end shoulder 357, the interfacing edge 358, and the base surface 359 of the collection crucible 350.

The paired crucible system 208 further comprises a flow control nozzle 270 positionable between the reaction crucible 220 and the collection crucible 350. In some embodiments, when the modular crucible loading unit 200 is assembled, the flow control nozzle 270 fluidly couples the reaction crucible 220 and the collection crucible 350. For example, the flow control nozzle 270 may be positioned between the open end 221 of the reaction crucible 220 and the open end 351 of the collection crucible 350, fluidly coupling the reaction crucible 220 to the collection crucible 350.

The flow control nozzle 270 comprises a nozzle body 271 and a flow channel 280 extending through the nozzle body 271 from an inlet opening 282 to an outlet opening 284. The nozzle body 271 further comprises a protruding outlet 272 extending outwards from the remainder of the nozzle body 271, for example, in an upwards direction. The flow channel 280 is positioned such that the outlet opening 284 is located at the protruding outlet 272. When assembled, the protruding outlet 272 of the flow control nozzle 270 extends into the collection chamber 354 of the collection crucible 350. This positions the outlet opening 284 within the collection chamber 354 of the collection crucible 350, minimizing loss of fluid (e.g., vaporized rare earth metal, such as vaporized ytterbium) when transferring from the reaction crucible 220 to the collection crucible 350, maximizing total mass recovery of the rare earth metal. In some embodiments, a mesh screen 206 is positioned in the flow channel 280, such that fluid flowing from the inlet opening 282 to the outlet opening 284 of the flow control nozzle 270 traverses the mesh screen 206. The mesh screen 206 blocks solids from transferring from the reaction crucible 220, increasing the purity of the material collected in the collection crucible 350.

The nozzle body 271 of the flow control nozzle 270 comprises an edge extension 274 positioned radially outward from the flow channel 280. The edge extension 274 extends outward from the remainder of the nozzle body 271, for example, in a downward direction. In some embodiments, the protruding outlet 272 and the edge extension 274 each extend outwards from the nozzle body 271 in opposite directions. These opposite directions may both be parallel to the flow channel 280. As depicted in FIG. 4A, when the modular crucible loading unit 200 is assembled, the edge extension 274 of the flow control nozzle 270 engages with the reaction crucible 220, for example, the interfacing edge 228 of the reaction crucible 220, forming a tortious interface between the flow control nozzle 270 and the reaction crucible 220. The tortious interface minimizes material loss during operation, when fluid is flowing from the reaction crucible 220, through the flow channel 280 of the flow control nozzle 270, and into the collection crucible 350.

Referring now to FIG. 4B, the paired crucible system 208′ is depicted. The paired crucible system 208′ comprises the reaction crucible 220′ and the collection crucible 350. In FIG. 4B, the collection crucible 350 is a unitary crucible. The reaction crucible 220′ comprises the crucible body 223 and the closed end 222 opposite the open end 221 and the reaction chamber 224. The reaction chamber 224 includes the chamber surface 225. A portion of the chamber surface 225 forms the chamber floor 226, which is the portion of the chamber surface 225 at the closed end 222 of the reaction crucible 220. The closed end 222 terminates at the base surface 229 of the reaction crucible 220. The paired crucible system 208′ further comprises a flow control nozzle 270′. The flow control nozzle 270′ comprises the nozzle body 271 and the flow channel 280 extending through the nozzle body 271 from the inlet opening 282 to the outlet opening 284. The nozzle body 271 further comprises the protruding outlet 272 extending outwards from the remainder of the nozzle body 271, for example, in an upwards direction. The flow channel 280 is positioned such that the outlet opening 284 is located at the protruding outlet 272. When assembled, the protruding outlet 272 of the flow control nozzle 270 extends into the collection chamber 354 of the collection crucible 350. This positions the outlet opening 284 within the collection chamber 354 of the collection crucible 350, minimizing loss of fluid (e.g., vaporized rare earth metal, such as vaporized ytterbium) when transferring from the reaction crucible 220′ to the collection crucible 350, maximizing total mass recovery of the rare earth metal. In some embodiments, the mesh screen 206 is positioned in the flow channel 280, such that fluid flowing from the inlet opening 282 to the outlet opening 284 of the flow control nozzle 270′ traverses the mesh screen 206. The mesh screen 206 blocks solids from transferring from the reaction crucible 220, increasing the purity of material collected in the collection crucible 350.

The nozzle body 271 of the flow control nozzle 270′ further comprises a barrier portion 276 positioned radially outward from the flow channel 280, the barrier portion 276 comprising a lipped edge 278. As depicted in FIGS. 4B, when the modular crucible loading unit 200 is assembled in some embodiments comprising the paired crucible system 208′, the lipped edge 278 of the flow control nozzle 270′ engages with the reaction crucible 220′, forming a tortious interface between the flow control nozzle 270′ and the reaction crucible 220′. The tortious interface minimizes material loss during operation, when fluid is flowing from the reaction crucible 220′, through the flow channel 280 of the flow control nozzle 270′, and into the collection crucible 350.

Referring now to FIG. 4C, the paired crucible system 208″ is depicted. The paired crucible system 208″ comprises the reaction crucible 220″ and the collection crucible 350. In FIG. 4C, the collection crucible 350 is a unitary crucible. The reaction crucible 220″ comprises the crucible body 223 and the closed end 222 opposite the open end 221 and the reaction chamber 224. The reaction chamber 224 includes the chamber surface 225. A portion of the chamber surface 225 forms the chamber floor 226, which is the portion of the chamber surface 225 at the closed end 222 of the reaction crucible 220. The closed end 222 terminates at the base surface 229 of the reaction crucible 220. The open end 221 of the reaction crucible 220″ includes a throat 230 comprising a throat channel 232 extending from a throat inlet 234 to a throat inlet 234. The throat 230 further comprises a throat barrier 231 partially enclosing the reaction chamber 224 of the reaction crucible 220. The throat channel 232 extends outward from the throat barrier 231, for example, in an upwards direction. In the embodiment depicted in FIG. 4C, when the modular crucible loading unit 200 is assembled, the throat inlet 234 extends into the collection chamber 354 of the collection crucible 350. In some embodiments, the mesh screen 206 is positioned in the throat channel 232 of the reaction crucible 220, such that fluid flowing from the throat inlet 234 to the throat outlet 236 traverses the mesh screen 206. The mesh screen 206 blocks solids, such as the second rare earth element (e.g., Lu-177), from transferring from the reaction crucible 220, maximizing the amount of the second rare earth metal, which may be a valuable material such as Lu-177, that is retained in the reaction crucible 220.

Referring now to FIGS. 4A-4C, the reaction crucible 220, 220′, 220″ and the collection crucible 350 comprise a material that is chemically non-reactive with ytterbium and are thermally conductive such that they may be actively heated or cooled. Example materials include steel, boron nitride, titanium nitride, quartz, glass, and ceramic, however, it should be understood that any material that is chemically non-reactive with the ytterbium may be used. In some embodiments, the reaction crucible 220, 220′, 220″ and the collection crucible 350 each comprise a refractory metal. Example refractory metals include tungsten, molybdenum, niobium, tantalum, and rhenium.

Referring now to FIGS. 3A-4C, the crucible heater 212 includes a crucible receiving recess 214 terminating at a heater base 216. In some embodiments, the crucible heater 212 is a resistive heater. However, it should be understood that other types of heaters are contemplated, for example, inductive heaters. When the modular crucible loading unit 200 is assembled, the reaction crucible 220, 220′, 220″ is positioned in the crucible receiving recess 214 of the crucible heater 212. In some embodiments, a non-conductive washer 204 is positioned between the base surface 229 of the reaction crucible 220 and the heater base 216, for example, embodiments in which the crucible heater 212 is a resistive heater. The non-conductive washer 204 separates the reaction crucible 220 from contacting the heater base 216. In operation, when current is flowing through the crucible heater 212 and thereby generating heat to heat the reaction crucible 220, the non-conductive washer 204 blocks current flow from the heater base 216 of the crucible heater 212 to the base surface 229 of the reaction crucible 220. In addition, the electrical break provided by the non-conductive washer 204 facilitates the use of resistance temperature detectors (RTDs) and thermocouples to measure temperature because current flow through the reaction crucible 220 would cause signal interference for the RTDs and thermocouples. In some embodiments, the non-conductive washer 204 comprises a felt material. In some embodiments, the non-conductive washer 204 is an annular shape with an opening in the center. In some embodiments, the non-conductive washer 204 does not include an opening, for example, the non-conductive washer 204 may be a disk shape without an opening.

Referring now to FIGS. 3A, 3B, and 5A-6B, the collection cooling plate 310 of the split collection crucible assembly 300 of the modular crucible loading unit 200 further comprises a plurality of alignment protrusions 318. At least one of the alignment protrusions 318 is positioned on the first side surface 317 of the collection cooling plate 310 and at least one of the alignment protrusions 318 is positioned on the second side surface 319 of the collection cooling plate 310. Each of the first side surface 317 and the second side surface 319 extend along outer sides of the plate body 313, for example, opposite outer sides of the plate body 313, between the underside surface 314 and the cold interfacing surface 316. Moreover, the first side surface 317 and the alignment protrusions 318 on the first side surface 317 are part of the first plate portion 312A. Similarly, the second side surface 319 and the alignment protrusions 318 on the second side surface 319 are part of the second plate portion 312B. The plurality of alignment protrusions 318 extend outward from the first side surface 317 and the second side surface 319. In some embodiments, the alignment protrusions 318 comprise alignment wheels, however, other alignment mechanisms are contemplated. The alignment protrusions 318 facilitate a slidable engagement between the collection cooling plate 310 and the docking station 100 and thus, facilitate a slidable engagement between the docking station 100 and the modular crucible loading unit 200.

Indeed, referring now to FIGS. 7A-7C, the docking station 100 further comprises a first alignment slot 122 and a second alignment slot 124 configured to receive the alignment protrusions 318 positioned on the first side surface 317 of the collection cooling plate 310 and the second side surface 319 of the collection cooling plate 310, respectively. The first alignment slot 122 and a second alignment slot 124 guide the modular crucible loading unit 200 into engagement with the docking station 100 such that the busbar 240 of the modular crucible loading unit 200 engages with the power socket port 120 of the docking station 100 and the collection cooling plate 310 of the split collection crucible assembly 300 engages with the cold plate 110 of the docking station 100. In some embodiments, one or more spring mechanisms may be positioned in the first alignment slot 122, the second alignment slot 124, or both the first alignment slot 122, the second alignment slot 124 and are configured to press the modular crucible loading unit 200 upwards toward the cold plate 110 when the modular crucible loading unit 200 is engaged with the docking station 100 to facilitate contact between the collection cooling plate 310 and the cold plate 110. In other embodiments, the one or more spring mechanisms are coupled to the cold plate 110 and configured to contact the underside surface 314 of the collection cooling plate 310, to bias the collection cooling plate 310 into contact with the cold plate 110. While the modular crucible loading unit 200 includes alignment protrusions 318 and the docking station 100 includes corresponding alignment slots 122, 124, it should be understood that embodiments are contemplated in which the alignment protrusions are positioned docking station 100 and the corresponding alignment slots are positioned in the modular crucible loading unit 200. Moreover, in some embodiments, the collection cooling plate 310 further comprises an alignment pin 311 extending from the cold interfacing surface 316 and configured to engage with an alignment notch 112 of the docking station 100. The alignment notch 112 is coupled to or integral with the cold plate 110. The alignment notch 112 may include an angular receiving portion 114 that makes first contact with the alignment pin 311 of the collection cooling plate 310 during engagement, lifting the collection cooling plate 310 into contact with the cold plate 110. Moreover, the engagement of the alignment pin 311 and the alignment notch 112 minimizes sagging of the modular crucible loading unit 200 when engaged with the docking station 100.

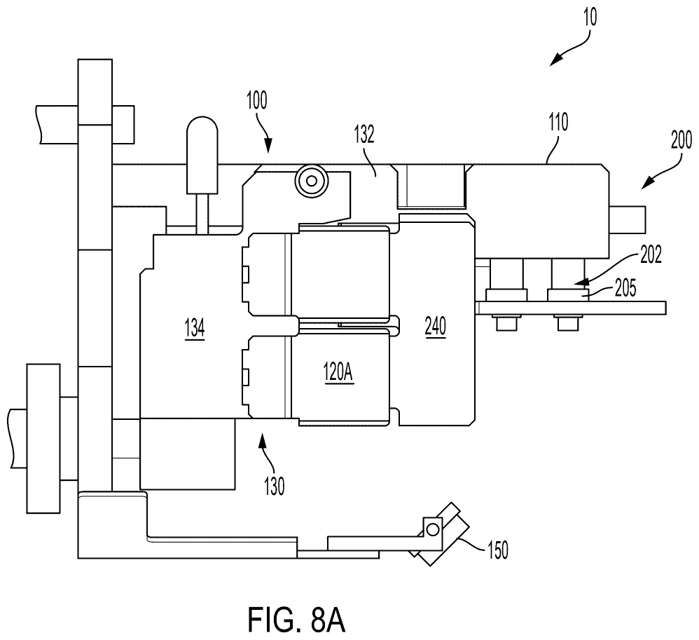

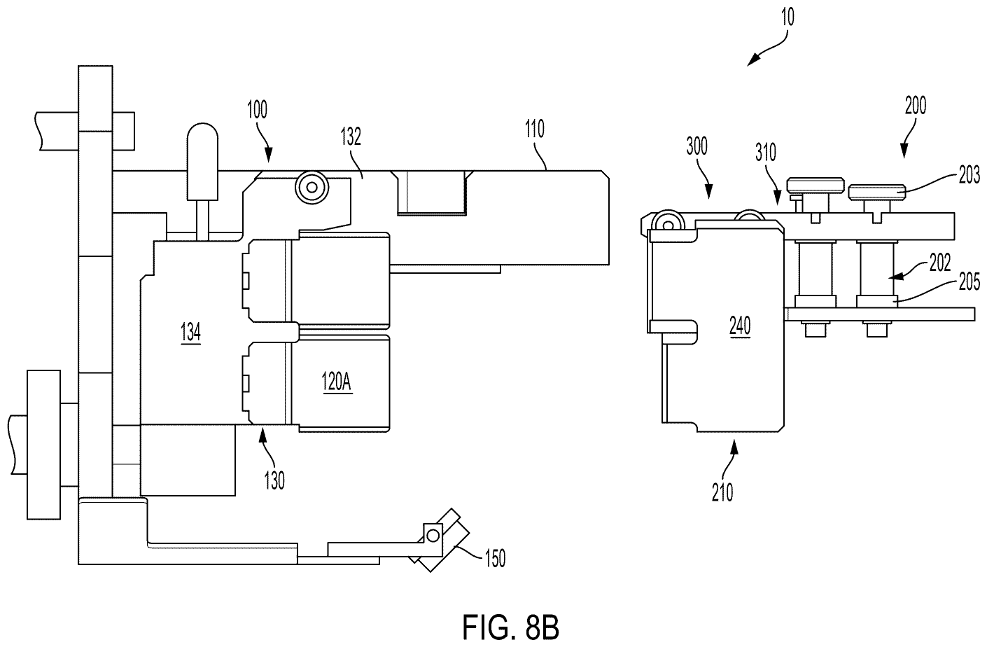

Referring now to FIGS. 8A and 8B and again FIGS. 1 and 2, the docking station 100 may further comprise an infrared mirror 150 configured to reflect infrared light from an infrared temperature sensor positioned external the vacuum chamber 12, optically coupling the infrared temperature sensor and the crucible heater 212 when the modular crucible loading unit 200 is engaged with the docking station 100. Indeed, the infrared mirror 150 may be positioned below, for example, directly below, the crucible heater 212 when the modular crucible loading unit 200 is engaged with the docking station 100. Thus, the infrared mirror 150 facilitates use of an externally positioned infrared temperature sensor to monitor temperature of the crucible heater 212 and the reaction crucible 220, 220′, 220″ during operation. This allows the infrared temperature sensor to be positioned away from the high temperature, low pressure, and potentially radioactive environment in the vacuum chamber 12 during operation.

Referring again to FIGS. 7A-7C, the docking station 100 may include a first side support structure 130 and a second side support structure 140. The first side support structure 130 couples the cold plate 110 to a first power socket port 120A and the second side support structure 140 couples the cold plate 110 to a second power socket port 120B. In some embodiments, the first side support structure 130 comprises an inner support plate 132 coupled to an outer support plate 134 and the second side support structure 140 each comprise an inner support plate 142 coupled to an outer support plate 144. The first alignment slot 122 is located in the inner support plate 132 of the first side support structure 130. The second alignment slot 124 is located in the inner support plate 142 of the second side support structure 140. The first alignment slot 122 faces the second alignment slot 124. The first power socket port 120A is coupled to the outer support plate 134 of the first side support structure 130 and the second power socket port 120B is coupled to the outer support plate 144 of the second side support structure 140. When the modular crucible loading unit 200 is engaged with the docking station 100, at least one alignment protrusion 318 on the first side surface 317 of the collection cooling plate 310 is engaged with the first alignment slot 122 and at least one alignment protrusion 318 on the second side surface 319 of the collection cooling plate 310 is engaged with the second alignment slot 124.

Referring now to FIGS. 1-8B, the isotope separation system 10 (or multiple different isotopes separation systems 10) may be used in several portions of a target radioisotope accumulation process, for example, during reduction, cold separation, and hot separation. The reduction process is performed to collect a rare earth metal composition, which may be used as the feedstock material to accumulate the target radioisotope, the cold separation process is used to separate non-radioactive materials, and the hot separation process is used to separate materials, at least one of which is radioactive, for example, a target radioisotope. In each of these sub-processes of the overall radioisotope accumulation process, a reaction material is positioned in the reaction crucible 220, 220′, 220″ of the modular crucible loading unit 200. The reaction material comprises at least two elements, for example, a first element and a second element. In each of the sub-processes of the overall radioisotope accumulation process described herein, a portion of the reaction material, such as the first element, phase separates from another portion of the reaction material, such as the second element, such that the separated portion of the reaction material (e.g., the first element) collects in the collection crucible 350 and the remaining portion of the reaction material (e.g., the second element) is retained in the reaction crucible 220, 220′, 220″. In each sub-process of the overall target radioisotope accumulation process, the collection crucible 350 may be a unitary crucible or a split crucible comprising the first crucible portion 360A and the second crucible portion 360B and the collection cooling plate 310 may be a unitary plate or a split plate comprising the first plate portion 312A and the second plate portion 312B. During cold separation sub-processes, it may be useful to use a split crucible to facilitate better access to the collected material which is next pelletized for irradiation. During reduction and hot separation, it may be useful to use a unitary crucible, since the collection material in each of the reduction and hot separation sub-processes is sublimated again as a next step, and the collection crucible 350 may then be used as the reaction crucible 220, 220′, 220″ in that next step of the overall accumulation process. Each of the sub-processes of the overall radioisotope accumulation process will now be described in more detail.

The reduction process includes positioning a powder mixture (e.g., a reaction material) comprising a rare earth oxide powder and a lanthanum powder in the reaction crucible 220, 220′, 220″ (for example, the reaction crucible 220′ of FIG. 4B) of the heating assembly 210 of the modular crucible loading unit 200. In some embodiments, the rare earth oxide powder comprises an ytterbium oxide powder. In some embodiments, the powder mixture is a homogeneous mixture of rare earth oxide powder and lanthanum powder. The reaction crucible 220, 220′, 220″ may be positioned in the crucible receiving recess 214 of the crucible heater 212. The reduction process also includes positioning the collection crucible 350 in the crucible slot 315 of the collection cooling plate 310.

During the reduction process, as well as the other subprocess of the radioisotope accumulation process, such as cold separation, and hot separation, when the collection crucible 350 is a unitary crucible, the collection crucible 350 may be positioned such that, when the first plate portion 312A and the second plate portion 312B of the collection colling plate 310 are placed in the engaged position, the collection crucible 350 is in the crucible slot 315 formed by the slot protrusions 330A, 330B of the first and second plate portions 312A, 312B. For example, the first plate portion 312A and the second plate portion 312 may be coupled together with fasteners and positioned nearly in contact, allowing the collection crucible 350 to be positioned between the first and second plate portions 312A, 312B, proximate each slot protection 330A, 330B, and thereafter the first and second plate portions 312A, 312B are placed into contact by tightening the fasteners, holding the collection crucible 350 in the crucible slot 315 by a friction fit. During the reduction process, as well as the other subprocess of the radioisotope accumulation process, such as cold separation, and hot separation, when the collection crucible 350 comprises a split crucible with the first crucible portion 360A and the second crucible portion 360B, the first crucible portion 360A may be coupled to the first plate portion 312A and the second crucible portion 30B may be coupled to the second portion 312B. Thus, when the first plate portion and the second plate portion are placed in the engaged position, the first crucible portion 360A contacts the second crucible portion 360, closing the closed end 352 of the collection crucible 350 and positioning the collection crucible in the crucible slot 315 of the collection cooling plate 310.

Once the powder mixture is loaded into the reaction crucible 220, 220′, 220″, the heating assembly 210 of the modular crucible loading unit 200 is coupled to the split collection crucible assembly 300 of the modular crucible loading unit 200 to align the open end 221 of the reaction crucible 220, 220′, 220″ with the open end 351 of the collection crucible 350. For example, the heating assembly 210 is coupled to the split collection crucible assembly 300 using the connectors 202. This creates fixed alignment between the open end 221 of the reaction crucible 220, 220′, 220″ and the open end 351 of the collection crucible 350. In some embodiments, the flow control nozzle 270, 270′ (e.g., the flow control nozzle 270′ of FIG. 4B) is positioned between the open end 221 of the reaction crucible 220, 220′, 220″ and the open end 351 of the collection crucible 350 before coupling the heating assembly 210 is coupled to the split collection crucible assembly 300.

Next, the modular crucible loading unit 200 is coupled to the docking station 100, which is positioned in the vacuum chamber 12. For example, the alignment protrusions 318 of the modular crucible loading unit 200 may be inserted into the alignment slots 122 of the collection cooling plate 310 and the modular crucible loading unit 200 may slide into the docking station 100 until the busbars 240 engage with the power socket ports 120A, 120B, electrically coupling the modular crucible loading unit 200 with the docking station 100. Moreover, once the modular crucible loading unit 200 is coupled to the docking station 100, the collection cooling plate 310 and the collection crucible 350 thermally couple to the cold plate 110 of the docking station 100. For example, the cold plate 110 is proximate, and in some embodiments, in direct contact with the cold interfacing surface 316 of the collection cooling plate 310. Moreover, in embodiments in which the crucible slot 315 extends through the plate body 313 from the underside surface 314 to the cold interfacing surface 316 and the base surface 359 of the collection crucible 350 is coincident with or extends beyond the cold interfacing surface 316, the cold plate 110 may be in direct contact with the base surface 359 of the collection crucible 350.

The reduction process next comprises heating the powder mixture to reduce the rare earth oxide powder into a rare earth metal composition that collects in the collection crucible 350. Heating the powder mixture may be done by applying heat to the reaction crucible 220, 220′, 220″ using the crucible heater 212. The applied heat may be generated by directing current from the power socket ports 120 of the docking station 100 through the busbars 240 and the crucible heater 212 of the heating assembly 210 of the modular crucible loading unit 200. Without intending to be limited by theory, when the powder mixture is heated, the lanthanum strips oxygen off of the ytterbium oxide, turning the ytterbium oxide into a ytterbium metal, and the ytterbium metal is vaporized. As heat is applied to the powder mixture, ytterbium metal may phase separate (via sublimation, distillation, or a combination thereof) from the powder mixture, separating from the ytterbium oxide, lanthanum, and lanthanum oxide, and collecting in the collection crucible 350. In contrast to the ytterbium oxide, lanthanum is retained in the reaction crucible 220, 220′, 220″ as heat is applied to the powder mixture. Thus, the ytterbium metal is separated from both the oxygen of the ytterbium oxide and from the lanthanum of the powder mixture. In some embodiments, the powder mixture is heated to a temperature in a range of from 200° C. to 1500° C. or 300° C. to 875° C., for example, a temperature of 300° C., 350° C., 400° C., 450° C., 500° C., 550° C., 600° C., 650° C., 700° C., 750° C., 800° C., 850° C., 900° C., 950° C., 1000° C., 1050° C., 1100° C., 1150° C., 1200° C., 1250° C., 1300° C., 1350° C., 1400° C., 1450° C., 1500° C., or any range having any two of these values as endpoints, or any value in a range having any two of these values as endpoints. In one example operation, the powder mixture is first preheated to a first temperature in a range of from 300° C. to 500° C., such as 400° C. and then ramped up to a second temperature in a range of from 1000° C. to 1500° C., for example, 1100° C., 1200° C., 1300° C., or 1400° C., to drive the reduction reaction.

In some embodiments, when heating the powder mixture, the modular crucible loading unit 200 (and thus the reaction crucible 220, 220′, 220″ and the collection crucible 350) may be positioned in an inert or reduced pressure environment, for example, within the vacuum chamber 12. The inert or reduced pressure environment in the vacuum chamber 12 may be an environment with a pressure in a range of from 700 torr to 1×10⁻⁸ torr, from 650 torr to 1×10⁻⁸ torr, from 600 torr to 1×10⁻⁸ torr, from 500 torr to 1×10⁻⁸ torr, from 400 torr to 1×10⁻⁸ torr, from 300 torr to 1×10⁻⁸ torr, from 250 torr to 1×10⁻⁷ torr, from 100 torr to 1×10⁻⁶ torr, from 1 torr to 1×10⁻⁶ torr, from 1×10⁻¹ torr to 1×10⁻⁶ torr, 1×10⁻³ or less, 1×10⁻⁵ torr or less, 1×10⁻⁶ torr or less, from 700 torr to 1×10⁻¹ torr, from 200 torr to 1 torr, from 100 torr to 1 torr, from 700 torr to 250 torr, any range having any two of these values as endpoints, or any value in a range having any two of these values as endpoints.

When heat is applied to the powder mixture, the collection crucible 350 is positioned facing (e.g., above) the reaction crucible 220, 220′, 220″ such that a gaseous form of the rare earth metal composition flows from the reaction crucible 220, 220′, 220″ into the collection crucible 350, for example, onto the collection surface 355. At the collection surface 355, the rare earth metal composition may solidify and stick to the collection surface 355 by condensation. In some embodiments, the collection crucible 350 may be actively cooled, for example, by a cooling fluid, to promote solidification of the rare earth metal composition onto the collection surface 355. Indeed, cooling fluid may flow within the cold plate 110 of the docking station 100, removing heat from the collection crucible 350 and the collection cooling plate 310. The rare earth metal composition that collects in the collection crucible 350 comprises a rare earth metal, such as ytterbium, and may comprise some impurities, such as one or more of lanthanum, titanium, vanadium, zinc, molybdenum, tungsten, and tantalum.

Next, the modular crucible loading unit 200 may be disengaged from the docking station 100, removed from the vacuum chamber 12, and the separated materials may be retrieved for further processing. After disengaging the modular crucible loading unit 200 from the docking station 100, the heating assembly 210 is separated from the split collection crucible assembly 300, allowing access to the materials in the reaction crucible 220, 220′, 220″ and the collection crucible 350. For example, after separating the heating assembly 210 from the split collection crucible 300, the first plate portion 312A and the second plate portion 312B may be disengaged, that is, placed in the disengaged position. When the collection crucible 350 is also split and comprises the first crucible portion 360A and the second crucible portion 360B, disengaging the first plate portion 312A from the second plate portion 312B separates the first crucible portion 360A from the second crucible portion 360B. In embodiments comprising a split collection crucible 350 and a unitary collection cooling plate 310, after separating heating assembly 210 from the split collection crucible 300, the collection crucible 350 may be removed from the crucible slot 315 of the collection cooling plate 310 and the first crucible portion 360A may be disengaged from the second crucible portion 360B. Next, the ytterbium oxide, lanthanum, and lanthanum oxide remaining the in the reaction crucible 220, 220′, 220″ may be removed and either stored or discarded, such that the reaction crucible 220, 220′, 220″ can be used for additional processing. In some embodiments, the rare earth metal (e.g., the ytterbium metal) may be removed from the collection crucible 350 for placement in another reaction crucible 220, 220′, 220″. In some embodiments, the collection crucible 350 in which the rare earth metal collected may be used as the reaction crucible 220, 220′, 220″ in the next processing step, which is a cold separation process.

The cold separation process of the target isotope accumulation process is next performed to purify the rare earth metal composition, phase separating the rare earth metal (e.g., an ytterbium metal) from any lanthanum metal or other impurities that collected in the collection crucible 350, together with the rare earth metal, during the reduction process. The isotope separation system 10 may be used to perform the cold separation process. For example, the rare earth metal composition (e.g., the reaction material) may be positioned in the reaction crucible 220, 220′, 220″ (for example, the reaction crucible 220 of FIG. 4A) of the heating assembly 210 of the modular crucible loading unit 200. In some embodiments, the collection crucible 350 used in the reduction process described above and in which the rare earth metal composition collected, may be used as the reaction crucible 220, 220′, 220″ in the cold separation process. Next, the reaction crucible 220, 220′, 220″ may be positioned in the crucible receiving recess 214 of the crucible heater 212. The cold separation process also includes positioning the collection crucible 350 in the crucible slot 315 of the collection cooling plate 310.

Once the rare earth metal composition is loaded into the reaction crucible 220, 220′, 220″, the heating assembly 210 of the modular crucible loading unit 200 is coupled to the split collection crucible assembly 300 of the modular crucible loading unit 200 to align the open end 221 of the reaction crucible 220, 220′, 220″ with the open end 351 of the collection crucible 350. For example, the heating assembly 210 is coupled to the split collection crucible assembly 300 using the connectors 202. This creates fixed alignment between the open end of the reaction crucible 220, 220′, 220″ and the open end of the collection crucible 350. In some embodiments, the flow control nozzle 270, 270′ (e.g., the flow control nozzle 270′ of FIG. 4A) is positioned between the open end of the reaction crucible 220, 220′, 220″ and the open end of the collection crucible 350 before coupling the heating assembly 210 to the split collection crucible assembly 300.

Next, the modular crucible loading unit 200 is coupled to the docking station 100, which is positioned in the vacuum chamber 12. For example, the alignment protrusions 318 of the modular crucible loading unit 200 may be inserted into the alignment slots 122 of the collection cooling plate 310 and the modular crucible loading unit 200 may slide into the docking station 100 until the busbars 240 engage with the power socket ports 120A, 120B, electrically coupling the modular crucible loading unit 200 with the docking station 100. Moreover, once the modular crucible loading unit 200 is coupled to the docking station 100, the collection cooling plate 310 and the collection crucible 350 thermally couple to the cold plate 110 of the docking station 100. For example, the cold plate 110 is proximate, and in some embodiments, in direct contact with the cold interfacing surface 316 of the collection cooling plate 310. Moreover, in embodiments in which the crucible slot 315 extends through the plate body 313 from the underside surface 314 to the cold interfacing surface 316 and the base surface 359 of the collection crucible 350 is coincident with or extending beyond the cold interfacing surface 316, the cold plate 110 may be in direct contact with the base surface 359 of the collection crucible 350.

The cold separation process next comprises heating the rare earth metal composition to phase separate the rare earth metal (e.g., an ytterbium metal) from the remainder of impurities present in the rare earth metal composition such that the rare earth metal collects in the collection crucible 350. Heating the rare earth metal composition may be done by applying heat to the reaction crucible 220, 220′, 220″ using the crucible heater 212. The applied heat may be generated by directing current from the power socket ports 120 of the docking station 100 through the busbars 240 and the crucible heater 212 of the heating assembly 210 of the modular crucible loading unit 200. Without intending to be limited by theory, when the rare earth metal composition is heated, the rare earth metal (e.g., the ytterbium metal) is vaporized. Indeed, as heat is applied to the rare earth metal composition, ytterbium metal may phase separate (via sublimation, distillation, or a combination thereof) from the remaining impurities of the rare earth metal composition powder mixture, which remain in a non-gaseous state in the reaction crucible 220, 220′, 220″. In some embodiments, the rare earth metal composition is heated to a temperature in a range of from 200° C. to 900° C. or 300° C. to 875° C., for example, a temperature of 300° C., 350° C., 400° C., 450° C., 500° C., 550° C., 600° C., 625° C., 650° C., 675° C., 700° C., 750° C., 800° C., 850° C., 900° C., or any range having any two of these values as endpoints, or any value in a range having any two of these values as endpoints. In one example operation, the rare earth metal composition is first preheated to a first temperature in a range of from 250° C. to 400° C., such as 300° C. and then ramped up to a second temperature in a range of from 550° C. to 800° C., for example, 600° C., 650° C., 700° C., or 750° C., to drive the phase change reaction.

In some embodiments, when heating the rare earth metal composition, the modular crucible loading unit 200 (and thus the reaction crucible 220, 220′, 220″ and the collection crucible 350) may be positioned in an inert or reduced pressure environment, for example, within the vacuum chamber 12. The inert or reduced pressure environment in the vacuum chamber 12 may be an environment with a pressure in a range of from 700 torr to 1×10⁻⁸ torr, from 650 torr to 1×10⁻⁸ torr, from 600 torr to 1×10⁻⁸ torr, from 500 torr to 1×10⁻⁸ torr, from 400 torr to 1×10⁻⁸ torr, from 300 torr to 1×10⁻⁸ torr, from 250 torr to 1×10⁻⁷ torr, from 100 torr to 1×10⁻⁶ torr, from 1 torr to 1×10⁻⁶ torr, from 1×10⁻¹ torr to 1×10⁻⁶ torr, 1×10⁻³ or less, 1×10⁻⁵ torr or less, 1×10⁻⁶ torr or less, from 700 torr to 1×10⁻¹ torr, from 200 torr to 1 torr, from 100 torr to 1 torr, from 700 torr to 250 torr, any range having any two of these values as endpoints, or any value in a range having any two of these values as endpoints.

When heat is applied to the rare earth metal composition, the collection crucible 350 is positioned facing (e.g., above) the reaction crucible 220, 220′, 220″ such that a gaseous form of a refined rare earth metal composition flows from the reaction crucible 220, 220′, 220″ into the collection crucible 350, for example, onto the collection surface 355. At the collection surface 355, the refined rare earth element composition may solidify and stick to the collection surface 355 by condensation. In some embodiments, the collection crucible 350 may be actively cooled, for example, by a cooling fluid, to promote solidification of the rare earth metal composition onto the collection surface 355. Indeed, cooling fluid may flow within the cold plate 110 of the docking station 100, removing heat from the collection crucible 350 and the collection cooling plate 310.

Next, the modular crucible loading unit 200 may be disengaged from the docking station 100, removed from the vacuum chamber 12, and the separated materials may be retrieved for further processing. After disengaging the modular crucible loading unit 200 from the docking station 100, the heating assembly 210 is separated from the split collection crucible assembly 300, allowing access to the materials in the reaction crucible 220, 220′, 220″ and the collection crucible 350. For example, after separating the heating assembly 210 from the split collection crucible 300, the first plate portion 312A and the second plate portion 312B may be disengaged, that is, placed in the disengaged position. When the collection crucible 350 is split and comprises the first crucible portion 360A and the second crucible portion 360B, disengaging the first plate portion 312A from the second plate portion 312B separates the first crucible portion 360A from the second crucible portion 360B. In embodiments comprising a split collection crucible 350 and a unitary collection cooling plate 310, after separating heating assembly 210 from the split collection crucible 300, the collection crucible 350 may be removed from the crucible slot 315 of the collection cooling plate 310 and the first crucible portion 360A may be disengaged from the second crucible portion 360B. Next, the impurities remaining the in the reaction crucible 220, 220′, 220″ may be removed and either stored or discarded, such that the reaction crucible 220, 220′, 220″ can be used for additional processing. In some embodiments, refined rare earth metal composition (e.g., the refined ytterbium composition) may be removed from the collection crucible 350 for placement further processing.

In some embodiments, the method may further comprise collecting the refined rare earth metal composition (e.g., the refined ytterbium composition) and, forming (e.g., pressing, pelletizing, or the like) the refined rare earth metal composition into a metal target. In some embodiments, the metal target comprises a metal pellet, which may be formed by pelletizing the refined first metal composition. The metal pellet may comprise a variety of shapes, such as a spherical shape, a cylindrical shape, an oblong shape, or the like. In some embodiments, the metal target comprises a metal foil. The metal target is substantially homogenous to facilitate uniform heat transfer and uniform irradiation. Next, the metal target may be irradiated with neutrons to form an irradiated composition comprising a first rare earth metal and a second rare earth metal (e.g., ytterbium and lutetium, such as Yb-176 and Lu-177). The metal target comprising the refined rare earth metal composition may be irradiated by neutrons generated using a nuclear reactor, a particle accelerator, such as an ion beam source, or any other known or yet to be developed neutron source.

Referring still to FIGS. 1-8B, the isotope separation system 10 may also be used in a hot separation process to separate the first rare earth metal and the second rare earth metal of the irradiated composition, via distillation or sublimation, isolating the target isotope (i.e., the second rare earth metal, which may comprise Lu-177) for accumulation. The hot separation process includes positioning the irradiated composition (e.g., the reaction material) comprising the first rare earth metal and the second rare earth metal (e.g., ytterbium and lutetium, such as Yb-176 and Lu-177) in the reaction crucible 220, 220′, 220″ (e.g., the reaction crucible 220″ of FIG. 4C) of the heating assembly 210 of the modular crucible loading unit 200. The reaction crucible 220, 220′, 220″ may be positioned in the crucible receiving recess 214 of the crucible heater 212. The hot separation process also includes positioning the collection crucible 350 in the crucible slot 315 of the collection cooling plate 310. Once the irradiated composition is loaded into the reaction crucible 220, 220′, 220″, the heating assembly 210 of the modular crucible loading unit 200 is coupled to the split collection crucible assembly 300 of the modular crucible loading unit 200 to align the open end of the reaction crucible 220, 220′, 220″ with the open end of the collection crucible 350. Indeed, in embodiments of the hot separation process using the reaction crucible 220″ of FIG. 4C, the throat inlet 234 of the reaction crucible 220″ extends into the collection chamber 354 of the collection crucible 350. For example, the heating assembly 210 is coupled to the split collection crucible assembly 300 using the connectors 202. This creates fixed alignment between the open end 221 of the reaction crucible 220, 220′, 220″ and the open end 351 of the collection crucible 350.

Next, the modular crucible loading unit 200 is coupled to the docking station 100, which is positioned in the vacuum chamber 12. For example, the alignment protrusions 318 of the modular crucible loading unit 200 be inserted into the alignment slots 122 of the collection cooling plate 310 and the modular crucible loading unit 200 may slide into the docking station 100 until the busbars 240 engage with the power socket ports 120A, 120B, electrically coupling the modular crucible loading unit 200 with the docking station 100. Moreover, once the modular crucible loading unit 200 is coupled to the docking station 100, the collection cooling plate 310 and the collection crucible 350 thermally couple to the cold plate 110 of the docking station 100. For example, the cold plate 110 is proximate, and in some embodiments, in direct contact with the cold interfacing surface 316 of the collection cooling plate 310. Moreover, in embodiments in which the crucible slot 315 extends through the plate body 313 from the underside surface 314 to the cold interfacing surface 316 and the base surface 359 of the collection crucible 350 is coincident with or extending beyond the cold interfacing surface 316, the cold plate 110 may be in direct contact with the base surface 359 of the collection crucible 350.

The hot separation process next comprises heating the irradiated composition to separate the first rare earth metal and the second rare earth metal of the irradiated composition, via distillation or sublimation, isolating the target isotope (i.e., the second rare earth metal, which may comprise Lu-177) for accumulation. Heating the irradiated composition may be done by applying heat to the reaction crucible 220, 220′, 220″ using the crucible heater 212. The applied heat may be generated by directing current from the power socket ports 120 of the docking station 100 through the busbars 240 and the crucible heater 212 of the heating assembly 210 of the modular crucible loading unit 200. For example, ytterbium may be phase separated (e.g., sublimated) from the irradiated composition in an environment at a temperature in a range of from 400° C. to 3000° C. to leave a target composition comprising a higher weight percentage of the target radioisotope (e.g., Lu-177) than was present in the irradiated composition. In some embodiments, the temperature in the environment is less than 700° C.

The temperature for the target radioisotope yielding hot sublimation (e.g., the temperature in the environment) may be in a range of from 400° C. to 3000° C., for example, from 450° C. to 1500° C., from 450° C. to 1200° C., from 450° C. to 1000° C., from 400° C. to 1000° C., from 400° C. to 900° C., from 400° C. to 800° C., from 450° C. to 700° C., from 400° C. to less than 700° C., from 400° C. to 695° C., from 450° C. to 690° C., from 450° C. to 685° C., from 450° C. to 680° C., from 450° C. to 675° C., from 450° C. to 670° C., from 450° C. to 665° C., from 450° C. to 660° C., from 450° C. to 655° C., from 450° C. to 650° C., from 450° C. to 645° C., from 450° C. to 640° C., from 450° C. to 635° C., from 450° C. to 630° C., from 450° C. to 625° C., 470° C. to about 630° C., from 800° C. to 3000° C., from greater than 800° C. to 3000° C., from 1000° C. to 3000° C., from 1200° C. to 3000° C., from 1500° C. to 3000° C., or any range having any two of these values as endpoints, or any value in a range having any two of these values as endpoints. Indeed, the temperature for sublimation and/or distillation (e.g., the temperature in the environment) may be 400° C., 425° C., 450° C., 470° C., 475° C., 500° C., 525° C., 550° C., 575° C., 600° C., 625° C., 640° C., 650° C., 655° C., 660° C., 665° C., 670° C., 675° C., 680° C., 685° C., 690° C., 695° C., 698° C., 700° C., 725° C., 750° C., 775° C., 800° C., 850° C., 900° C., 950° C., 1000° C., 1100° C., 1200° C., 1300° C., 1400° C., 1500° C., 1600° C., 1700° C., 1800° C., 1900° C., 2000° C., 2100° C., 2200° C., 2300° C., 2400° C., 2500° C., 2600° C., 2700° C., 2800° C., 2900° C., 3000° C., or any range having any two of these values as endpoints, or any value in a range having any two of these values as endpoints.

In some embodiments, when heating the irradiated composition, the modular crucible loading unit 200 (and thus the reaction crucible 220, 220′, 220″ and the collection crucible 350) may be positioned in an inert or reduced pressure environment, for example, within the vacuum chamber 12. The inert or reduced pressure environment in the vacuum chamber 12 may be an environment with a pressure in a range of from 700 torr to 1×10⁻⁸ torr, from 650 torr to 1×10⁻⁸ torr, from 600 torr to 1×10⁻⁸ torr, from 500 torr to 1×10⁻⁸ torr, from 400 torr to 1×10⁻⁸ torr, from 300 torr to 1×10⁻⁸ torr, from 250 torr to 1×10⁻⁷ torr, from 100 torr to 1×10⁻⁶ torr, from 1 torr to 1×10⁻⁶ torr, from 1×10⁻¹ torr to 1×10⁻⁶ torr, 1×10⁻³ or less, 1×10⁻⁵ torr or less, 1×10⁻⁶ torr or less, from 700 torr to 1×10⁻¹ torr, from 200 torr to 1 torr, from 100 torr to 1 torr, from 700 torr to 250 torr, any range having any two of these values as endpoints, or any value in a range having any two of these values as endpoints.

When heat is applied to the irradiated composition, the collection crucible 350 is positioned facing (e.g., above) the reaction crucible 220, 220′, 220″ such that a gaseous form of the first rare earth metal (e.g., ytterbium, such as Yb-176) flows from the reaction crucible 220, 220′, 220″ into the collection crucible 350, for example, onto the collection surface 355. At the collection surface 355, the first rare earth metal may solidify and stick to the collection surface 355 by condensation. This leaves a high concentration of the second rare earth metal (e.g., a target radioisotope such as Lu-177) in the reaction crucible 220, 220′, 220″. In some embodiments, the collection crucible 350 may be actively cooled, for example, by a cooling fluid, to promote solidification of the rare earth metal composition onto the collection surface 355. Indeed, cooling fluid may flow within the cold plate 110 of the docking station 100, removing heat from the collection crucible 350 and the collection cooling plate 310.

Next, the modular crucible loading unit 200 may be disengaged from the docking station 100, removed from the vacuum chamber 12, and the separated materials may be retrieved for further processing. After disengaging the modular crucible loading unit 200 from the docking station 100, the heating assembly 210 is separated from the split collection crucible assembly 300, allowing access to the materials in the reaction crucible 220, 220′, 220″ and the collection crucible 350. For example, after separating the heating assembly 210 from the split collection crucible 300, the first plate portion 312A and the second plate portion 312B may be disengaged, that is, placed in the disengaged position. When the collection crucible 350 is split and comprises the first crucible portion 360A and the second crucible portion 360B, disengaging the first plate portion 312A from the second plate portion 312B separates the first crucible portion 360A from the second crucible portion 360B. In embodiments comprising a split collection crucible 350 and a unitary collection cooling plate 310, after separating heating assembly 210 from the split collection crucible 300, the collection crucible 350 may be removed from the crucible slot 315 of the collection cooling plate 310 and the first crucible portion 360A may be disengaged from the second crucible portion 360B. Next, the lutetium composition remaining in the reaction crucible 220, 220′, 220″ may be collected and subjected to further purification processing, such as chromatographic separation to further purify the lutetium (e.g., the Lu-177) in the lutetium composition. Alternatively, the lutetium composition may be subjected to a non-aqueous separation technique to further purify the lutetium in the lutetium composition, such as a non-aqueous, electrolytic reduction process using mercury.

Upon collection in the collection crucible 350, in embodiments in which the first rare earth metal is an ytterbium composition, the ytterbium composition may comprise both Yb-176 and Yb-175. This ytterbium composition is available for recycling (e.g., for another round of neutron irradiation) to produce further irradiated composition and to thereafter produce further lutetium in subsequent runs of the process. In some embodiments, the recycling of a collected ytterbium composition to produce further irradiated composition and to thereafter produce further lutetium in subsequent runs of the process, may be done using the methods described in U.S. patent application Ser. No. 18/218,960, which is incorporated herein by reference in its entirety. The method may comprise retaining the first rare earth metal for a waiting period to form a decayed first metal composition. The waiting period may be at least 4 days, for example, at least 5 days, at least 6 days, at least 1 week, at least 2 weeks, at least 3 weeks, at least 4 weeks, at least 5 weeks, at least 6 weeks, at least 7 weeks, at least 8 weeks, at least 9 weeks, at least 10 weeks, at least 11 weeks, at least 12 weeks, at least 13 weeks, at least 15 weeks, or longer, such as at least 52 weeks or at least 104 weeks. In embodiments in which the first rare earth metal composition comprises a ytterbium composition, during the waiting period, the Yb-175 present in the ytterbium composition decays partially into Lu-175, forming a decayed ytterbium composition. The half-life of Yb-175 is about 4 days. Indeed, in an 8-week waiting period, 99.991% of the Yb-175 present in the ytterbium composition decays into Lu-175. In some embodiments, the ytterbium composition may be retained for a waiting period after which 50% or more of the Yb-175 present in the ytterbium composition decays into Lu-175, for example, 75% or more, 90% or more, 95% or more, 95% or more, 99.3% or more, 99.5% or more, 99.7% or more, 99.9% or more, 99.95% or more, 99.97% or more, 99.99% or more, 99.995% or more, 99.999% or more, or 99.9999% or more.

Lu-175 is stable and non-radioactive. Lu-175 is also a contaminant in Lu-177 based radiopharmaceuticals. Lu-175 degrades the specific activity of Lu-177 based radiopharmaceuticals because it is stable and non-radioactive. Lu-175 can also lead to the formation of Lu-176m during the next irradiation of the process described herein. Minimizing Lu-175 and Lu-176m may be required to meet purity requirements for some radiopharmaceutical products. The production of Lu-177m2 occurs from Lu-176 and has a half-life of approximately 160 days, which poses a hazard to patients as it can remain in the body and potentially result in off-target cell damage.

Retaining the ytterbium composition allows most of the Yb-175 to decay to Lu-175 and form the decayed ytterbium composition. This allows the Lu-175 to be removed from the decayed ytterbium composition with an additional cold separation process, for example, using the isotope separation system 10. Subsequent to the waiting period, an additional cold separation process may be performed to separate ytterbium (e.g., Yb-176) present in the decayed ytterbium composition from the lutetium (e.g., Lu-175) that formed during the decay period.

Indeed, this additional cold separation process includes positioning the decayed ytterbium composition (e.g., the reaction material) in the reaction crucible 220, 220′, 220″ (for example, the reaction crucible 220 of FIG. 4A) of the heating assembly 210 of the modular crucible loading unit 200. Next, the reaction crucible 220, 220′, 220″ may be positioned in the crucible receiving recess 214 of the crucible heater 212. This cold separation process also includes positioning the collection crucible 350 in the crucible slot 315 of the collection cooling plate 310. Once the decayed ytterbium composition is loaded into the reaction crucible 220, 220′, 220″, the heating assembly 210 of the modular crucible loading unit 200 is coupled to the split collection crucible assembly 300 of the modular crucible loading unit 200 to align the open end 221 of the reaction crucible 220, 220′, 220″ with the open end 351 of the collection crucible 350. For example, the heating assembly 210 is coupled to the split collection crucible assembly using the connectors 202. This creates fixed alignment between the open end 221 of the reaction crucible 220, 220′, 220″ and the open end 351 of the collection crucible 350. In some embodiments, the flow control nozzle 270, 270′ (e.g., the flow control nozzle 270′ of FIG. 4A) is positioned between the open end of the reaction crucible 220, 220′, 220″ and the open end of the collection crucible 350 before coupling the heating assembly 210 to the split collection crucible assembly 300.

Next, the modular crucible loading unit 200 is coupled to the docking station 100, which is positioned in the vacuum chamber 12. For example, the alignment protrusions 318 of the modular crucible loading unit 200 may be inserted into the alignment slots 122 of the collection cooling plate 310 and the modular crucible loading unit 200 may slide into the docking station 100 until the busbars 240 engage with the power socket ports 120A, 120B, electrically coupling the modular crucible loading unit 200 with the docking station 100. Moreover, once the modular crucible loading unit 200 is coupled to the docking station 100, the collection cooling plate 310 and the collection crucible 350 thermally couple to the cold plate 110 of the docking station 100. For example, the cold plate 110 is proximate, and in some embodiments, in direct contact with the cold interfacing surface 316 of the collection cooling plate 310. Moreover, in embodiments in which the crucible slot 315 extends through the plate body 313 from the underside surface 314 to the cold interfacing surface 316 and the base surface 359 of the collection crucible 350 is coincident with or extending beyond the cold interfacing surface 316, the cold plate 110 may be in direct contact with the base surface 359 of the collection crucible 350.

The additional cold separation process next comprises heating the decayed ytterbium composition to phase separate the ytterbium from the remainder of impurities (such as lutetium-175) present in the decayed ytterbium composition such that the ytterbium collects in the collection crucible 350. Heating the rare earth metal composition may be done by applying heat to the reaction crucible 220, 220′, 220″ using the crucible heater 212. The applied heat may be generated by directing current from the power socket ports 120 of the docking station 100 through the busbars 240 and the crucible heater 212 of the heating assembly 210 of the modular crucible loading unit 200. Without intending to be limited by theory, when the decayed ytterbium composition is heated, the ytterbium metal present in the decayed ytterbium composition is vaporized. Indeed, as heat is applied to the decayed ytterbium composition, ytterbium metal may phase separate (via sublimation, distillation, or a combination thereof) from the remaining impurities of the decayed ytterbium composition, which remain in a non-gaseous state in the reaction crucible 220, 220′, 220″ (e.g., a waste composition). In some embodiments, the rare earth metal composition is heated to a temperature in a range of from 400° C. to 3000° C., for example, from 450° C. to 1500° C., from 450° C. to 1200° C., from 450° C. to 1000° C., from 400° C. to 1000° C., from 400° C. to 900° C., from 400° C. to 800° C., from 450° C. to 700° C., from 400° C. to less than 700° C., from 400° C. to 695° C., from 450° C. to 690° C., from 450° C. to 685° C., from 450° C. to 680° C., from 450° C. to 675° C., from 450° C. to 670° C., from 450° C. to 665° C., from 450° C. to 660° C., from 450° C. to 655° C., from 450° C. to 650° C., from 450° C. to 645° C., from 450° C. to 640° C., from 450° C. to 635° C., from 450° C. to 630° C., from 450° C. to 625° C., 470° C. to about 630° C., from 800° C. to 3000° C., from greater than 800° C. to 3000° C., from 1000° C. to 3000° C., from 1200° C. to 3000° C., from 1500° C. to 3000° C., or any range having any two of these values as endpoints, or any value in a range having any two of these values as endpoints.

When heat is applied to the decayed ytterbium composition, the collection crucible 350 is positioned facing (e.g., above) the reaction crucible 220, 220′, 220″ such that a gaseous form of a refined ytterbium composition flows from the reaction crucible 220, 220′, 220″ into the collection crucible 350, for example, onto the collection surface 355. At the collection surface 355, the refined ytterbium composition may solidify and stick to the collection surface 355 by condensation. In some embodiments, the collection crucible 350 may be actively cooled, for example, by a cooling fluid, to promote solidification of the refined ytterbium composition onto the collection surface 355. Indeed, cooling fluid may flow within the cold plate 110 of the docking station 100, removing heat from the collection crucible 350 and the collection cooling plate 310.

Next, the modular crucible loading unit 200 may be disengaged from the docking station 100, removed from the vacuum chamber 12, and the separated materials may be retrieved for further processing. After disengaging the modular crucible loading unit 200 from the docking station 100, the heating assembly 210 is separated from the split collection crucible assembly 300, allowing access to the materials in the reaction crucible 220, 220′, 220″ and the collection crucible 350. For example, after separating the heating assembly 210 from the split collection crucible 300, the first plate portion 312A and the second plate portion 312B may be disengaged, that is, placed in the disengaged position. When the collection crucible 350 is split and comprises the first crucible portion 360A and the second crucible portion 360B, disengaging the first plate portion 312A from the second plate portion 312B separates the first crucible portion 360A from the second crucible portion 360B. In embodiments comprising a split collection crucible 350 and a unitary collection cooling plate 310, after separating heating assembly 210 from the split collection crucible 300, the collection crucible 350 may be removed from the crucible slot 315 of the collection cooling plate 310 and the first crucible portion 360A may be disengaged from the second crucible portion 360B. Next, the impurities remaining the in the reaction crucible 220, 220′, 220″ may be removed and either stored or discarded, such that the reaction crucible 220, 220′, 220″ can be used for additional processing. In some embodiments, refined rare earth metal composition (e.g., the refined ytterbium composition) may be removed from the collection crucible 350 for placement further processing. In some embodiments, the refined ytterbium composition may comprise 0.1 weight percent (wt. %) Lu-175 or less, for example, 0.05 wt. % or less, 0.02 wt. % or less, 0.01 wt. % or less, 0.005 wt. % or less, 0.004 wt. % or less, 0.003 wt. % or less, 0.002 wt. % or less, 0.001 wt. % or less, 0.0005 wt. % or less, 0.0001 wt. % or less, or any range having any two of these values as endpoints, or any value in a range having any two of these values as endpoints.

By separating the refined ytterbium composition and the waste composition, the refined ytterbium composition comprises a higher weight percentage of ytterbium than was present in the decayed ytterbium composition. In addition to Lu-175, the waste composition may further comprise one or more ytterbium oxides, one or more ytterbium silicates, and elements with a low vapor pressure, such as lanthanum, iron, aluminum, nickel, copper, cerium, tin, erbium, cobalt, silicon, chromium, tantalum, titanium, molybdenum, manganese, and mixtures and alloys thereof. Each of these is undesirable in a Lu-177 based radiopharmaceutical. Moreover, these impurities may also be undesirable when the refined ytterbium composition is irradiated. Without intending to be limited by theory, the impurities could cause an excessive radiative does to facility operators if the impurities were irradiated and activated in a neutron source facility, such as a reactor. In other words, removing the waste composition from the decayed ytterbium composition (i.e., forming the refined ytterbium composition) acts as a purification step to remove the impurities from the decayed ytterbium composition, impurities that form the waste composition.

In some embodiments, the method may further comprise collecting the refined metal composition (e.g., the refined ytterbium composition) and, forming (e.g., pressing, pelletizing, or the like) the refined metal composition into a metal target. In some embodiments, the metal target comprises a metal pellet, which may be formed by pelletizing the refined metal composition. The metal pellet may comprise a variety of shapes, such as a spherical shape, a cylindrical shape, an oblong shape, or the like. In some embodiments, the metal target comprises a metal foil. The metal target is substantially homogenous to facilitate uniform heat transfer and uniform irradiation. Next, the metal target may be irradiated with neutrons to form a recycled irradiated composition comprising a first rare earth metal and a second rare earth metal (e.g., ytterbium and lutetium, such as Yb-176 and Lu-177). The metal target may be irradiated by neutrons generated using a nuclear reactor, a particle accelerator, such as an ion beam source, or any other known or yet to be developed neutron source.

Next, the recycled irradiated composition (e.g., the reaction material) may undergo the hot separation process described above to separate the first rare earth metal and the second rare earth metal of the recycled irradiated composition, via distillation or sublimation, isolating additional target isotope (i.e., the second rare earth metal) for accumulation, using the process described above for separating the irradiated composition. The second rare earth metal (e.g., lutetium) and the separated first rare earth element (e.g., ytterbium) may each be collected. The process may be repeated on the collected first rare earth element, which continues to benefit from the repeatable and reliable positioning of the components of the modular crucible loading unit 200 and the docking station 100 of the isotope separation system 10 during the target isotope accumulation process, minimizing loss of ytterbium during the reduction process and the cold separation process and minimizing the loss of both lutetium and ytterbium (in both their separated compositional form and a combined compositional form) during the hot separation process, which are rare and expensive materials. This allows the lutetium and ytterbium to be reprocessed with minimal loss, and used to collect additional high purity lutetium, such as additional Lu-177. In some embodiments, multiple isotope separation systems 10 are contemplated to perform different segments of the methods described herein. For example, one isotope separation system 10 may be used for the reduction process, another isotope separation system 10 may be used for cold purification of a rare earther metal composition, another isotope separation system 10 may be used for hot separation, and yet another isotope separation system 10 may be used for the recycling process to purify decayed material post hot separation.

The present disclosure can be further understood in view of the following aspects.

Aspect 1 is a split collection crucible assembly comprising a collection crucible; and a collection cooling plate comprising a first plate portion removably coupled to a second plate portion, wherein when the first plate portion and the second plate portion are in an engaged position, a crucible slot is formed between the first plate portion and the second plate portion and the collection crucible is positionable in the crucible slot.

Aspect 2 is the split collection crucible assembly of aspect 1, wherein when the first plate portion and the second plate portion are in the engaged position, the first plate portion contacts the second plate portion and when the first plate portion and the second plate portion are in a disengaged position, the first plate portion is spaced apart from the second plate portion.

Aspect 3 is the split collection crucible assembly of aspect 1 or 2, wherein when the first plate portion and the second plate portion are in the engaged position, an interior assembly surface of the first plate portion contacts an interior assembly surface of the second plate portion.

Aspect 4 is the split collection crucible assembly of any of aspects 1-3, wherein the collection crucible comprises a first crucible portion coupled to the first plate portion of the collection cooling plate and a second crucible portion coupled to the second plate portion of the collection cooling plate.

Aspect 5 is the split collection crucible assembly of aspect 4, wherein: the first and second plate portions of the collection crucible each comprise one or more edge protrusions; and the first and second crucible portions of the collection crucible each comprise one or more edge notches.

Aspect 6 is the split collection crucible assembly of aspect 5, wherein: the one or more edge protrusions of the first plate portion are coupled to the one or more edge notches of the first crucible portion thereby coupling the first crucible portion to the first plate portion; and the one or more edge protrusions of the second plate portion are coupled to the one or more edge notches of the second crucible portion thereby coupling the second crucible portion to the second plate portion.

Aspect 7 is the split collection crucible assembly of any of aspects 1-6, wherein: the first plate portion comprises a slot protrusion positioned at an interior assembly surface of the first plate portion and extending from an underside surface of the first plate portion; and the second plate portion comprises a slot protrusion positioned at an interior assembly surface of the second plate portion and extending from an underside surface of the second plate portion.

Aspect 8 is the split collection crucible assembly of aspect 7, wherein the slot protrusion of the first plate portion comprises a crucible receiving wall and the slot protrusion of the second plate portion comprises a crucible receiving wall, wherein when the first plate portion is coupled to the second plate portion, the crucible receiving wall of the first and second plate portions collectively define the crucible slot.

Aspect 9 is the split collection crucible assembly of aspects 7 or 8, wherein: the slot protrusion of the first plate portion comprises one or more fastener receiving juts extending along the interior assembly surface; and the slot protrusion of the second plate portion comprises one or more fastener receiving juts extending along the interior assembly surface.

Aspect 10 is the split collection crucible assembly of aspect 9, further comprising a plurality of fasteners positioned in fastener holes of the one or more fastener receiving juts of the first plate portion and the second plate portion, thereby coupling the first plate portion and the second plate portion.

Aspect 11 is the split collection crucible assembly of aspect 10, wherein the first plate portion and the second plate portion are translatable between the engaged position and a disengaged position using at least one of the plurality of fasteners.

Aspect 12 is the split collection crucible assembly of aspect 11, wherein in the disengaged positioned, the first plate portion is spaced apart from the second plate portion and the at least one of the plurality of fasteners connects the first plate portion and the second plate portion.

Aspect 13 is the split collection crucible assembly of any of aspects 1-12, wherein: the crucible slot formed by the first plate portion and the second plate portion of the cooling plate in the engaged position extends to a cold interfacing surface of the cooling plate; and the collection crucible is positioned in the crucible slot such that a base surface of the collection crucible is coincident with or extends beyond the cold interfacing surface.

Aspect 14 is a split collection crucible assembly comprising: a collection cooling plate comprising a crucible slot; and a collection crucible positioned in the crucible slot, wherein: the collection crucible comprises a first crucible portion removably coupled to a second crucible portion; the first crucible portion and the second crucible portion each comprise an interior assembly surface extending from an open end of the collection crucible to a closed end of the collection crucible; and contact between the interior assembly surfaces of the first crucible portion and the second crucible portion forms a releasable interface that seals the closed end of the collection crucible.

Aspect 15 is the split collection crucible assembly of aspect 14, wherein the first crucible portion and the second crucible portion each comprise one or more edge notches that form a gap between the first crucible portion and the second crucible portion when the interior assembly surfaces of the first crucible portion and the second crucible portion are in contact.

Aspect 16 is the split collection crucible assembly of aspect 14 or 15, wherein: the first crucible portion comprises an interface protrusion extending along the interior assembly surface and an interface recess extending along the interior assembly surface; the second crucible portion comprises an interface protrusion extending along the interior assembly surface and an interface recess extending along the interior assembly surface; the interface protrusion of the first crucible portion is positioned in the interface recess of the second crucible portion; and the interface protrusion of the second crucible portion is positioned in the interface recess of the first crucible portion.

Aspect 17 is the split collection crucible assembly of aspect 16, wherein: the interface protrusion of the first crucible portion extends along the interior assembly surface from the open end to the closed end; the interface recess of the first crucible portion extends along the interior assembly surface from the open end to the closed end; the interface protrusion of the second crucible portion extends along the interior assembly surface from the open end to the closed end; and the interface recess of the second crucible portion extends along the interior assembly surface from the open end to the closed end.

Aspect 18 is a modular crucible loading unit comprising: a heating assembly comprising a crucible heater and a reaction crucible; and a split collection crucible assembly comprising a collection crucible and a collection cooling plate, wherein: the collection cooling plate comprises a crucible slot; the collection crucible is positioned in the crucible slot; at least one of the collection crucible and the collection cooling plate are split into two portions; and the heating assembly is removably engageable with the split collection crucible assembly into an engaged position in which an open end of the reaction crucible faces an open end of the collection crucible.

Aspect 19 is modular crucible loading unit of aspect 18, wherein the collection crucible comprises a first crucible portion and a second crucible portion.

Aspect 20 is the modular crucible loading unit of aspect 19, wherein: the first crucible portion and the second crucible portion each comprise an interior assembly surface extending from an open end of the collection crucible to a closed end of the collection crucible; and contact between the interior assembly surfaces of the first crucible portion and the second crucible portion forms a releasable interface that seals the closed end of the collection crucible.

Aspect 21 is the modular crucible loading unit of aspect 20, wherein the first crucible portion and the second crucible portion each comprise one or more edge notches that form a gap between the first crucible portion and the second crucible portion when the interior assembly surfaces of the first crucible portion and the second crucible portion are in contact.

Aspect 22 is the modular crucible loading unit of aspects 20 or 21, wherein: the first crucible portion comprises an interface protrusion extending along the interior assembly surface and an interface recess extending along the interior assembly surface; the second crucible portion comprises an interface protrusion extending along the interior assembly surface and an interface recess extending along the interior assembly surface; the interface protrusion of the first crucible portion is positioned in the interface recess of the second crucible portion; and the interface protrusion of the second crucible portion is positioned in the interface recess of the first crucible portion.

Aspect 23 is the modular crucible loading unit of aspect 22, wherein: the interface protrusion of the first crucible portion extends along the interior assembly surface from the open end to the closed end; the interface recess of the first crucible portion extends along the interior assembly surface from the open end to the closed end; the interface protrusion of the second crucible portion extends along the interior assembly surface from the open end to the closed end; and the interface recess of the second crucible portion extends along the interior assembly surface from the open end to the closed end.

Aspect 24 is the modular crucible loading unit of any of aspect 18-23, wherein the collection cooling plate comprises a first plate portion and a second plate portion.

Aspect 25 is the modular crucible loading unit of aspect 24, wherein: when the first plate portion and the second plate portion are in the engaged position, the first plate portion contacts the second plate portion; and when the first plate portion and the second plate portion are in a disengaged position, the first plate portion is spaced apart from the second plate portion.

Aspect 26 is the modular crucible loading unit of aspect 24 or 25, wherein when the first plate portion and the second plate portion are in the engaged position, an interior assembly surface of the first plate portion contacts an interior assembly surface of the second plate portion.

Aspect 27 is the modular crucible loading unit of aspect 26, wherein the collection crucible comprises a first crucible portion coupled to the first plate portion of the collection cooling plate and a second crucible portion coupled to the second plate portion of the collection cooling plate.

Aspect 28 is the modular crucible loading unit of aspect 27, wherein: the first and second plate portions of the collection crucible each comprise one or more edge protrusions; and the first and second crucible portions of the collection crucible each comprise one or more edge notches.

Aspect 29 is the modular crucible loading unit of aspect 28, wherein: the one or more edge protrusions of the first plate portion are coupled to the one or more edge notches of the first crucible portion thereby coupling the first crucible portion to the first plate portion; and the one or more edge protrusions of the second plate portion are coupled to the one or more edge notches of the second crucible portion thereby coupling the second crucible portion to the second plate portion.

Aspect 30 is the modular crucible loading unit of any of aspects 24-29, wherein: the first plate portion comprises a slot protrusion positioned at an interior assembly surface of the first plate portion and extending from an underside surface of the first plate portion; and the second plate portion comprises a slot protrusion positioned at an interior assembly surface of the second plate portion and extending from an underside surface of the second plate portion.

Aspect 31 is the modular crucible loading unit of aspect 30, wherein the slot protrusion of the first plate portion comprises a crucible receiving wall and the slot protrusion of the second plate portion comprises a crucible receiving wall, wherein when the first plate portion is coupled to the second plate portion, the crucible receiving wall of the first and second plate portions collectively define the crucible slot.

Aspect 32 is the modular crucible loading unit of any of aspects 18-31, wherein the open end of the reaction crucible includes a throat comprising a throat channel extending from a throat inlet to a throat outlet and, when the heating assembly is coupled to the split collection crucible assembly, the throat outlet extends into a collection chamber of the collection crucible.

Aspect 33 is the modular crucible loading unit of aspect 32, wherein a mesh screen is positioned in the throat channel of the reaction crucible, such that fluid flowing from the throat inlet to the throat outlet traverses the mesh screen.

Aspect 34 is the modular crucible loading unit of any of aspects 18-33, wherein the modular crucible loading unit further comprises a flow control nozzle and when the heating assembly is coupled to the split collection crucible assembly, the flow control nozzle fluidly couples the reaction crucible and the collection crucible.

Aspect 35 is the modular crucible loading unit of aspect 34, wherein the flow control nozzle comprises a nozzle body and a flow channel extending through the nozzle body from an inlet opening to an outlet opening, wherein the outlet opening is located at a protruding outlet of the collection crucible.

Aspect 36 is the modular crucible loading unit of aspect 35, wherein the protruding outlet of the flow control nozzle extends into a collection chamber of the collection crucible.

Aspect 37 is the modular crucible loading unit of aspect 35 or 36, wherein a mesh screen is positioned in the flow channel, such that fluid flowing from the inlet opening to the outlet opening traverses the mesh screen.

Aspect 38 is the modular crucible loading unit of any of aspects 35-37, wherein the nozzle body comprises a barrier portion positioned radially outward from the flow channel, and the barrier portion comprises a lipped edge.

Aspect 39 is the modular crucible loading unit of aspect 38, wherein the lipped edge of the flow control nozzle forms a tortious interface between the flow control nozzle and the reaction crucible.

Aspect 40 is the modular crucible loading unit of any of aspects 18-39, wherein the crucible heater comprises a crucible receiving recess and the reaction crucible is positioned in the crucible receiving recess.

Aspect 41 is the modular crucible loading unit of aspect 40, wherein the crucible receiving recess terminates at a heater base.

Aspect 42 is the modular crucible loading unit of aspect 41, wherein the reaction crucible comprises a base surface at a closed end of the reaction crucible and a non-conductive washer is positioned between the base surface of the reaction crucible and the heater base, thereby blocking current flow from the heater base to the base surface.

Aspect 43 is the modular crucible loading unit of aspect 42, wherein the non-conductive washer comprises a felt material.

Aspect 44 is the modular crucible loading unit of aspect 42 or 43, wherein the non-conductive washer separates the reaction crucible from contacting the heater base.

Aspect 45 is the modular crucible loading unit of any of aspects 18-44, wherein the heating assembly and the split collection crucible assembly of the modular crucible loading unit are removably coupled by one or more connectors.

Aspect 46 is the modular crucible loading unit of aspect 45, wherein the one or more connectors comprise a standoff portion that forms an electrical break between the heating assembly and the split collection crucible assembly.

Aspect 47 is the modular crucible loading unit of aspect 45 or 46, wherein the one or more connectors comprise a manipulator screw.

Aspect 48 is the modular crucible loading unit of any of aspects 18-47, wherein the reaction crucible and the collection crucible each comprise a refractory metal.

Aspect 49 is the modular crucible loading unit of any of aspects 18-48, wherein the reaction crucible and the collection crucible each comprise a material that is chemically non-reactive with ytterbium.

Aspect 50 is an isotope separation system comprising: a docking station comprising a power socket port and a cold plate; the modular crucible loading unit of any of aspects 18-49, wherein: the heating assembly further comprises a busbar electrically coupled to the crucible heater; and the modular crucible loading unit is removably engageable with the docking station.

Aspect 51 is the isotope separation system of aspect 50, wherein when the modular crucible loading unit is engaged with the docking station, the busbar of the heating assembly is electrically coupled to the power socket port of the docking station and the collection cooling plate is thermally coupled to the cold plate of the docking station.

Aspect 52 is the isotope separation system of aspect 50 or 51, wherein the collection cooling plate comprises a plurality of alignment protrusions, wherein at least one of the plurality of alignment protrusions is on a first side of the collection cooling plate and at least one of the plurality of alignment protrusions is on a second side of the collection cooling plate.

Aspect 53 is the isotope separation system of aspect 52, wherein: the docking station comprises a first alignment slot and a second alignment slot; and when the modular crucible loading unit is engaged with the docking station, the at least one alignment protrusion on the first side of the collection cooling plate is engaged with the first alignment slot and the at least one alignment protrusion on the second side of the collection cooling plate is engaged with the second alignment slot.

Aspect 54 is the isotope separation system of any of aspects 50-53, wherein the collection cooling plate comprises an alignment pin extending from a cold interfacing surface and the docking station comprises an alignment notch; and when the modular crucible loading unit is engaged with the docking station, the alignment pin is engaged with the alignment notch such that the cold interfacing surface contacts the cold plate of the docking station.

Aspect 55 is the isotope separation system of any of aspects 50-54, wherein the docking station comprises one or more spring mechanisms; and when the modular crucible loading unit is engaged with the docking station, the one or more spring mechanisms press the collection cooling plate into contact with the cold plate of the docking station.

Aspect 56 is the isotope separation system of any of aspects 50-55, wherein when the modular crucible loading unit is engaged with the docking station, the collection cooling plate is in direct contact with the cold plate of the docking station.

Aspect 57 is the isotope separation system of any of aspects 50-56, further comprising a vacuum chamber, wherein the docking station is housed within the vacuum chamber.

Aspect 59 is the isotope separation system of any of aspects 50-57, wherein the crucible heater is a resistive heater.

Aspect 59 is a method comprising: heating a crucible heater of a heating assembly, wherein: the heating assembly comprises a reaction crucible; a reaction material comprising a first element and a second element is positioned in the reaction crucible; and heating the crucible heater also heats the reaction material such that at least a portion of the first element phase separates from the reaction material to leave a higher weight composition of the second element in the reaction crucible than was present in the reaction crucible; collecting the first element in a collection crucible of a split collection crucible assembly; wherein: the split collection crucible assembly further comprises a collection cooling plate comprising a crucible slot; the collection crucible is positioned in the crucible slot; and at least one of the collection crucible and the collection cooling plate are split into two portions.

Aspect 60 is the method of aspect 59, wherein the collection crucible comprises a first crucible portion and a second crucible portion.

Aspect 61 is the method of aspect 60, wherein: the first crucible portion and the second crucible portion each comprise an interior assembly surface extending from an open end of the collection crucible to a closed end of the collection crucible; and contact between the interior assembly surfaces of the first crucible portion and the second crucible portion forms a releasable interface that seals the closed end of the collection crucible.

Aspect 62 is the method of aspect 60 or 61, wherein the first crucible portion and the second crucible portion each comprise one or more edge notches that form a gap between the first crucible portion and the second crucible portion when the interior assembly surfaces of the first crucible portion and the second crucible portion are in contact.

Aspect 63 is the method of any of aspects 60-62, further comprising: removing the collection crucible from the crucible slot of the collection cooling plate; disengaging the first crucible portion from the second crucible portion; and removing the first element from the collection crucible.

Aspect 60 is the method of aspect 63, further comprising uncoupling the heating assembly and the split collection crucible assembly after collecting the first element in the collection crucible and prior to disengaged the first crucible portion from the second crucible portion.

Aspect 65 is the method of any of aspects 59-64, wherein the collection cooling plate comprises a first plate portion and a second plate portion.

Aspect 66 is the method of aspect 65, further comprising disengaging the first plate portion from the second plate portion; and removing the first element from the collection crucible.

Aspect 67 is the method of aspect 66, further comprising uncoupling the heating assembly and the split collection crucible assembly after collecting the first element in the collection crucible and prior to disengaged the first plate portion from the second plate portion.

Aspect 68 is the method of aspect 65 or 66, wherein: when the first plate portion and the second plate portion are in the engaged position, the first plate portion contacts the second plate portion; and when the first plate portion and the second plate portion are in a disengaged position, the first plate portion is spaced apart from the second plate portion.

Aspect 69 is the method of any of aspects 65-68, wherein when the first plate portion and the second plate portion are in the engaged position, an interior assembly surface of the first plate portion contacts an interior assembly surface of the second plate portion.

Aspect 70 is the method of aspect 69, wherein the collection crucible comprises a first crucible portion coupled to the first plate portion of the collection cooling plate and a second crucible portion coupled to the second plate portion of the collection cooling plate such that disengaging the first plate portion from the second plate portion separates the first crucible portion from the second crucible portion.

Aspect 71 is the method of aspect 70, wherein: the first and second plate portions of the collection crucible each comprise one or more edge protrusions; and the first and second crucible portions of the collection crucible each comprise one or more edge notches.

Aspect 72 is the method of aspect 71, wherein: the one or more edge protrusions of the first plate portion are coupled to the one or more edge notches of the first crucible portion thereby coupling the first crucible portion to the first plate portion; and the one or more edge protrusions of the second plate portion are coupled to the one or more edge notches of the second crucible portion thereby coupling the second crucible portion to the second plate portion.

Aspect 73 is the method of any of aspects 65-72, wherein: the first plate portion comprises a slot protrusion positioned at an interior assembly surface of the first plate portion and extending from an underside surface of the first plate portion; and the second plate portion comprises a slot protrusion positioned at an interior assembly surface of the second plate portion and extending from an underside surface of the second plate portion.

Aspect 74 is the method of aspect 73, wherein the slot protrusion of the first plate portion comprises a crucible receiving wall and the slot protrusion of the second plate portion comprises a crucible receiving, wherein when the first plate portion is engaged with the second plate portion, the crucible receiving of the first and second plate portions collectively define the crucible slot.

Aspect 75 is the method of any of aspects 59-74, wherein when heating the crucible heater and collecting the first element in the collection crucible, the collection crucible of the split collection crucible assembly is positioned above the reaction crucible of the heating assembly.

Aspect 76 is the method of any of aspects 59-75, wherein the crucible heater is a resistive heater and heating the crucible heater comprises directing electrical current through the crucible heater.

Aspect 77 is the method of any of aspects 59-76, wherein when heating the crucible heater and collecting the first element in the collection crucible, the heating assembly and the split collection crucible assembly are coupled using one or more connectors, wherein the one or more connectors comprise a standoff portion that forms an electrical break between the heating assembly and the split collection crucible assembly.

Aspect 78 is a method comprising: inserting a modular crucible loading unit into a docking station housed in a vacuum chamber, thereby electrically coupling a busbar of a heating assembly of the modular crucible loading unit to a power socket port of the docking station and thermally coupling a collection cooling plate of a split collection crucible assembly of the modular crucible loading unit to a cold plate of the docking station, wherein: the heating assembly further comprises a reaction crucible and a crucible heater, wherein the crucible heater is electrically coupled to the busbar; the collection cooling plate comprises a crucible slot; a collection crucible is positioned in the crucible slot; at least one of the collection crucible and the collection cooling plate are split into two portions; and the heating assembly is coupled to the split collection crucible assembly such that an open end of the reaction crucible faces an open end of the collection crucible.

Aspect 79 is the method of aspect 78, further comprising, prior to inserting the modular crucible loading unit into the docking station, positioning a reaction material in the reaction crucible and positioning the reaction crucible in a crucible receiving recess of the crucible heater.

Aspect 80 is the method of aspect 78 or 79, further comprising, prior to inserting the modular crucible loading unit into the docking station, coupling the heating assembly to the split collection crucible assembly using one or more connectors, wherein the one or more connectors comprise a standoff portion that forms an electrical break between the heating assembly and the split collection crucible assembly.

Aspect 81 is the method of any of aspects 78-80, wherein a reaction material is positioned in the reaction crucible.

Aspect 82 is the method of aspect 81, wherein the reaction material comprises a first element and a second element.

Aspect 83 is the method of aspect 82, further comprising: heating the crucible heater, thereby heating the reaction material such that at least a portion of the first element phase separates from the reaction material to leave a higher weight composition of the second element in the reaction crucible than was present in the reaction crucible; and collecting the first element in the collection crucible.

Aspect 84 is the method of aspect 83, wherein, when heating the crucible heater, an environment in the vacuum chamber comprises a reduced pressure.

Aspect 85 is the method of aspect 83 or 84, wherein, when heating the crucible heater, the method further comprises inducing cooling fluid flow within the cold plate, thereby cooling the collection crucible.

Aspect 86 is the method of any of aspects 83-85, further comprising, subsequent to collecting the first element in the collection crucible, disengaging the modular crucible loading unit from the docking station and separating the split collection crucible assembly of the modular crucible loading unit from the heating assembly of the modular crucible loading unit.

Aspect 87 is the method of any of aspects 83-85, wherein the first element of the reaction material comprises ytterbium and the second element of the reaction material comprises lutetium.

Aspect 88 is the method of any of aspects 83-85, wherein the reaction material comprises an irradiated composition, the first element comprises ytterbium and the second element comprises lutetium, the lutetium comprising lutetium-177.

Aspect 89 is the method of any of aspects 83-85, wherein the reaction material comprises a powder mixture comprises a ytterbium oxide powder and a lanthanum powder, wherein the first element comprises ytterbium and the second element comprises lanthanum.

Aspect 90 is the method of any of aspects 83-85, wherein the reaction material comprises a rare earth metal composition comprising ytterbium metal and lanthanum metal, wherein the first element comprises ytterbium and the second element comprises lanthanum.

Aspect 91 is the method of any of aspects 78-90, wherein the collection crucible comprises a first crucible portion and a second crucible portion.

Aspect 92 is the method of aspect 91, further comprising: removing the collection crucible from the crucible slot of the collection cooling plate; disengaging the first crucible portion from the second crucible portion; and removing the first element from the collection crucible.

Aspect 93 is the method of any of aspects 78-92, wherein the collection cooling plate comprises a first plate portion and a second plate portion.

Aspect 94 is the method of aspect 93, further comprising disengaging the first plate portion from the second plate portion; and removing the first element from the collection crucible.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical values or idealized geometric forms provided. Accordingly, these terms should be interpreted as indicating that insubstantial or inconsequential modifications or alterations of the subject matter described and claimed are considered to be within the scope of the disclosure as recited in the appended claims.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, optical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A modular crucible loading unit comprising:
a heating assembly comprising a crucible heater and a reaction crucible; and
a split collection crucible assembly comprising a collection crucible and a collection cooling plate, wherein:
the collection cooling plate comprises a crucible slot;
the collection crucible is positioned in the crucible slot;
at least one of the collection crucible and the collection cooling plate are split into two portions; and
the heating assembly is removably engageable with the split collection crucible assembly into an engaged position in which an open end of the reaction crucible faces an open end of the collection crucible.

2. The modular crucible loading unit of claim 1, wherein the collection crucible comprises a first crucible portion and a second crucible portion.

3. The modular crucible loading unit of claim 2, wherein:
the first crucible portion and the second crucible portion each comprise an interior assembly surface extending from an open end of the collection crucible to a closed end of the collection crucible; and
contact between the interior assembly surfaces of the first crucible portion and the second crucible portion forms a releasable interface that seals the closed end of the collection crucible.

4. The modular crucible loading unit of claim 3, wherein the first crucible portion and the second crucible portion each comprise one or more edge notches that form a gap between the first crucible portion and the second crucible portion when the interior assembly surfaces of the first crucible portion and the second crucible portion are in contact.

5. The modular crucible loading unit of claim 3, wherein:
the first crucible portion comprises an interface protrusion extending along the interior assembly surface and an interface recess extending along the interior assembly surface;
the second crucible portion comprises an interface protrusion extending along the interior assembly surface and an interface recess extending along the interior assembly surface;
the interface protrusion of the first crucible portion is positioned in the interface recess of the second crucible portion; and
the interface protrusion of the second crucible portion is positioned in the interface recess of the first crucible portion.

6. The modular crucible loading unit of claim 5, wherein:
the interface protrusion of the first crucible portion extends along the interior assembly surface from the open end to the closed end;
the interface recess of the first crucible portion extends along the interior assembly surface from the open end to the closed end;
the interface protrusion of the second crucible portion extends along the interior assembly surface from the open end to the closed end; and
the interface recess of the second crucible portion extends along the interior assembly surface from the open end to the closed end.

7. The modular crucible loading unit of claim 1, wherein the collection cooling plate comprises a first plate portion and a second plate portion.

8. The modular crucible loading unit of claim 7, wherein when the first plate portion and the second plate portion are in the engaged position, an interior assembly surface of the first plate portion contacts an interior assembly surface of the second plate portion.

9. The modular crucible loading unit of claim 8, wherein the collection crucible comprises a first crucible portion coupled to the first plate portion of the collection cooling plate and a second crucible portion coupled to the second plate portion of the collection cooling plate.

10. The modular crucible loading unit of claim 9, wherein:
the first and second plate portions of the collection crucible each comprise one or more edge protrusions;
the first and second crucible portions of the collection crucible each comprise one or more edge notches;
the one or more edge protrusions of the first plate portion are coupled to the one or more edge notches of the first crucible portion thereby coupling the first crucible portion to the first plate portion; and
the one or more edge protrusions of the second plate portion are coupled to the one or more edge notches of the second crucible portion thereby coupling the second crucible portion to the second plate portion.

11. The modular crucible loading unit of claim 1, wherein the crucible heater comprises a crucible receiving recess and the reaction crucible is positioned in the crucible receiving recess.

12. The modular crucible loading unit of claim 1, wherein the heating assembly and the split collection crucible assembly of the modular crucible loading unit are removably coupled by one or more connectors that comprise a standoff portion that forms an electrical break between the heating assembly and the split collection crucible assembly.

13. A isotope separation system comprising:
a docking station comprising a power socket port and a cold plate;
the modular crucible loading unit of claim 1, wherein:
the heating assembly further comprises a busbar electrically coupled to the crucible heater; and
the modular crucible loading unit is removably engageable with the docking station.

14. The isotope separation system of claim 13, wherein when the modular crucible loading unit is engaged with the docking station, the busbar of the heating assembly is electrically coupled to the power socket port of the docking station and the collection cooling plate is thermally coupled to the cold plate of the docking station.

15. The isotope separation system of claim 13, further comprising a vacuum chamber, wherein the docking station is housed within the vacuum chamber.

16. A method comprising:
inserting a modular crucible loading unit into a docking station housed in a vacuum chamber, thereby electrically coupling a busbar of a heating assembly of the modular crucible loading unit to a power socket port of the docking station and thermally coupling a collection cooling plate of a split collection crucible assembly of the modular crucible loading unit to a cold plate of the docking station, wherein:
the heating assembly further comprises a reaction crucible and a crucible heater, wherein the crucible heater is electrically coupled to the busbar;
the collection cooling plate comprises a crucible slot;
a collection crucible is positioned in the crucible slot; and
at least one of the collection crucible and the collection cooling plate are split into two portions; and
the heating assembly is coupled to the split collection crucible assembly such that an open end of the reaction crucible faces an open end of the collection crucible.

17. The method of claim 16, further comprising, prior to inserting the modular crucible loading unit into the docking station, positioning a reaction material in the reaction crucible and positioning the reaction crucible in a crucible receiving recess of the crucible heater.

18. The method of claim 16, further comprising, prior to inserting the modular crucible loading unit into the docking station, coupling the heating assembly to the split collection crucible assembly using one or more connectors, wherein the one or more connectors comprise a standoff portion that forms an electrical break between the heating assembly and the split collection crucible assembly.

19. The method of claim 16, wherein a reaction material comprising a first element and a second element is positioned in the reaction crucible.

20. The method of claim 19, further comprising:
heating the crucible heater, thereby heating the reaction material such that at least a portion of the first element phase separates from the reaction material to leave a higher weight composition of the second element in the reaction crucible than was present in the reaction crucible; and
collecting the first element in the collection crucible.

21. The method of claim 20, wherein, when heating the crucible heater, an environment in the vacuum chamber comprises a reduced pressure.

22. The method of claim 20, wherein, when heating the crucible heater, the method further comprises inducing cooling fluid flow within the cold plate, thereby cooling the collection crucible.

23. The method of claim 20, further comprising, subsequent to collecting the first element in the collection crucible, disengaging the modular crucible loading unit from the docking station and separating the split collection crucible assembly of the modular crucible loading unit from the heating assembly of the modular crucible loading unit.

24. The method of claim 20, wherein the first element of the reaction material comprises ytterbium and the second element of the reaction material comprises lutetium.

25. The method of claim 20, wherein the reaction material comprises a powder mixture comprises a ytterbium oxide powder and a lanthanum powder, wherein the first element comprises ytterbium and the second element comprises lanthanum.

26. The method of claim 20, wherein the reaction material comprises a rare earth metal composition comprising ytterbium metal and lanthanum metal, wherein the first element comprises ytterbium and the second element comprises lanthanum.

27. The method of claim 16, wherein the collection crucible comprises a first crucible portion and a second crucible portion and the method further comprises:
removing the collection crucible from the crucible slot of the collection cooling plate;
disengaging the first crucible portion from the second crucible portion; and
removing the first element from the collection crucible.

28. The method of claim 16, wherein the collection cooling plate comprises a first plate portion and a second plate portion and the method further comprises:
disengaging the first plate portion from the second plate portion; and
removing the first element from the collection crucible.
